(19) United States
(12) Patent Application Publication
(10) Pub. No.: US 2016/0259725 A1
(43) Pub. Date: Sep. 8, 2016

(54) STORAGE APPARATUS, COMPUTER SYSTEM, AND METHOD

(71) Applicant: HITACHI, LTD.,, Chiyoda-ku, Tokyo (JP)

(72) Inventors: Erika NISHIMOTO, Tokyo (JP); Hirokazu OGASAWARA, Tokyo (JP)

(73) Assignee: HITACHI, LTD., Tokyo (JP)

(21) Appl. No.: 14/426,136

(22) PCT Filed: Jul. 7, 2014
(86) PCT No.: PCT/JP2014/068046

§ 371 Date: Mar. 4, 2015

(51) Int. Cl. G06F 12/08

(52) U.S. Cl. CPC G06F 12/08; G06F 2212/1041; G06F 2212/152; G06F 2212/65

(57) ABSTRACT

A controller creates a basic volume based on the plurality of physical storage devices, creates a first virtual volume based on the basic volume, creates a first auxiliary volume based on the plurality of physical storage devices, and stores area information for associating a basic storage area with a first virtual storage area. In the case in which a read request to the first virtual storage area is issued, the controller determines whether or not a first auxiliary storage area is associated with the first virtual storage area based on the area information. In the case in which the first auxiliary storage area is not associated with the first virtual storage area, the controller executes a read access to the basic storage area. In the next place, the controller measures a read access frequency to the basic storage area. In the case in which the read access frequency to the basic storage area is a value equal to or larger than a predetermined first copy threshold value, the controller copies data of the basic storage area to the first auxiliary storage area and stores that the first auxiliary storage area as substitute for the basic storage area is associated with the first virtual storage area into the area information.

### TECHNICAL FIELD

The present invention relates to a technique for a load balance of a storage apparatus.

### BACKGROUND ART

For a computer system, a technique for creating a virtual volume based on a primary volume for storing the master data common for a plurality of virtual computers to create a virtual computer and a data volume for storing the update data of the master data to each virtual computer are known.

For instance, Patent Literature 1 discloses a technique for providing a snapshot that can be updated to a plurality of virtual NAS by having a volume for storing the original data that is utilized by a plurality of virtual NAS and a volume for storing a difference corresponded to the update data for every virtual NAS.

For such a computer system, the capacity efficiency of a computer system is promoted by storing the write data based on a write access to a virtual volume into not a primary volume but a data volume.

### CITATION LIST

### Patent Literature

### [PTL 1]

Japanese Patent Application Laid-Open Publication No. 2010-102479

### SUMMARY OF INVENTION

### Technical Problem

For the conventional computer system, the write data based on a write access to a virtual volume is stored into a data volume as the update data. Consequently, in the case in which a read access to the update data for a virtual volume occurs, the update data that has been stored into a data volume is read. However, in the case in which a read access to the master data that has not been updated occurs in a virtual volume, the master data that has been stored into a primary volume is read. Therefore, a load to a primary volume is increased in some cases. In particular, for a computer system that is provided with a plurality of virtual computers, in the case in which accesses from a plurality of users are concentrated on a primary volume, a load to the primary volume is increased unfortunately.

### Solution to Problem

The present invention was made in order to solve the above problems. A storage apparatus in accordance with a mode of the present invention comprises a controller coupled to a host computer and a plurality of physical storage devices coupled to the controller. The controller creates a basic volume based on the plurality of physical storage devices, creates a first virtual volume based on the basic volume, creates a first auxiliary volume based on the plurality of physical storage devices, and stores area information indicating that a basic storage area in the basic volume is associated with a first virtual storage area in a first virtual volume. In the case in which a read request to the first virtual storage area is issued from the host computer, the controller determines whether or not a first auxiliary storage area in the first auxiliary volume is associated with the first virtual storage area based on the area information. In the case in which the first auxiliary storage area is not associated with the first virtual storage area, the controller executes a read access to the basic storage area. The controller measures a read access frequency to the basic storage area. In the case in which the read access frequency to the basic storage area is a value equal to or larger than a predetermined first copy threshold value, the controller copies data of the basic storage area to the first auxiliary storage area and stores that the first auxiliary storage area as substitute for the basic storage area is associated with the first virtual storage area into the area information.

### Advantageous Effects of Invention

By a mode of the present invention, a load to a basic volume can be reduced.

### BRIEF DESCRIPTION OF DRAWINGS

FIG. 1 is a view illustrating an outline of a computer system in accordance with an embodiment 1.

FIG. 2 is an example of a physical block diagram showing of a computer system in accordance with an embodiment 1.

FIG. 3 is a view illustrating a pool 45.

FIG. 4 is a view showing a volume related management table 408.

FIG. 5 is a view showing a data reference destination management table 409.

FIG. 6 is a view showing a D-VOL management table 410.

FIG. 7 is a view showing an MR-VOL management table 404.

FIG. 8 is a view showing a pool management table 406.

FIG. 9 is a view showing an HR-VOL management table 405.

FIG. 10 is a view showing a first-half part of a flowchart of an I/O processing.

FIG. 11 is a view showing a second-half part of the I/O flowchart.

FIG. 12 is a flowchart of a data migration processing of an HR-VOL 13.

FIG. 13 is a flowchart of a data migration processing of an MR-VOL 17.

FIG. 14 is a flowchart of a dynamic placement processing of an MR-VOL 17.

FIG. 15 is a view showing a first-half part of a flowchart of an MR-VOL creation processing.

FIG. 16 is a view showing a second-half part of a flowchart of an MR-VOL creation processing.

FIG. 17 is a view showing a first-half part of a flowchart of an MR-VOL erasion processing.

FIG. 18 is a view showing a second-half part of a flowchart of an MR-VOL erasion processing.

FIG. 19 is a view illustrating a modified example of a computer system.

### DESCRIPTION OF EMBODIMENTS

An embodiment of the present invention will be described below in detail with reference to the figures. In the figures, equivalent elements illustrated in figures are numerically numbered similarly. However, the present invention is not restricted to the embodiment, and a wide variety of applications that meet the concept of the present invention is included in the technical scope of the present invention. Moreover, the number of each of compositional elements can be a plural number or a single number unless otherwise limited.

In the following descriptions, while a variety of information will be described in the expression of “xxx table” in some cases, the information can be represented by a data structure other than a table. In order to indicate that the information is not depended on a data structure, the expression of “xxx table” can also be referred to as “xxx information”.

In the following descriptions, the processing will be described while a “program” is handled as a subject in some cases. In the case in which the program is executed by a processor (a CPU (Central Processing Unit) for instance), since the processor executes the predetermined processing by using a storage resource (such as a memory) and a communication interface apparatus (such as a communication port) as it decides proper, a subject of a processing can also be a processor. Moreover, the processor can also include dedicated hardware in addition to the CPU. A computer program can be installed from a program source to each of the computers. The program source can also be a program distribution server or a storage medium for instance.

While each element can be identified by the identification information such as an ID, a number, and an identifier, the information of other kind such as a name can also be used, provided that the information can be identified. In the following descriptions, as substitute for a reference symbol of a drawing, the identification information such as an ID, an identifier, and a number is used as the information for identifying an object in some cases.

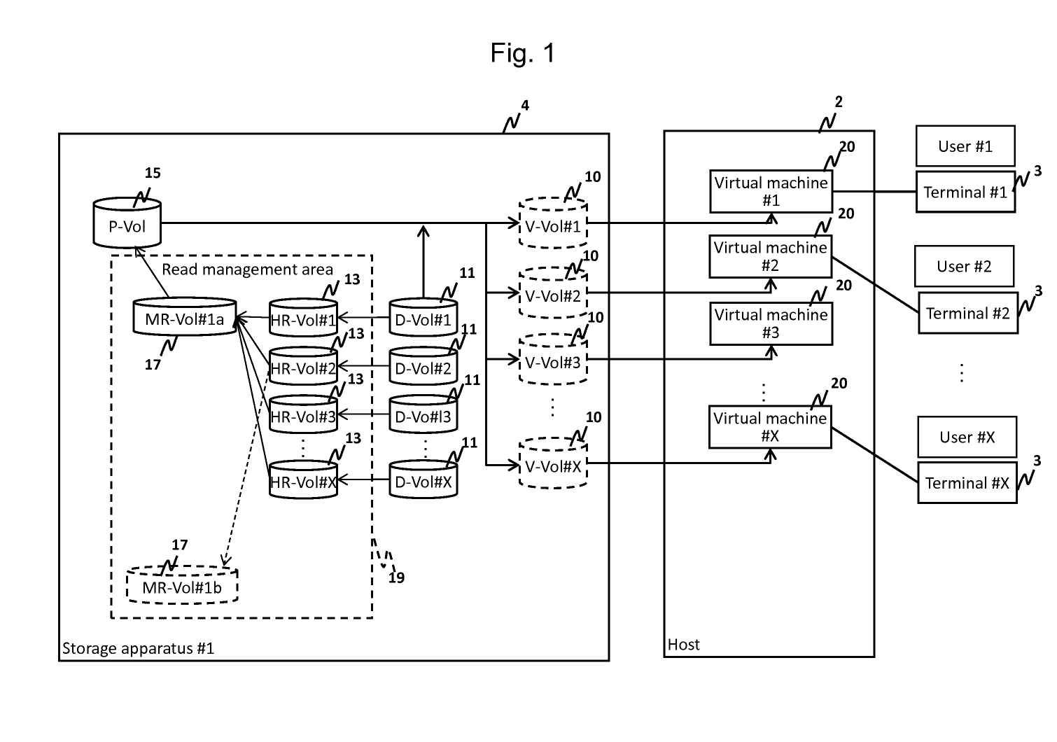

An embodiment of the present invention will be described in the following. FIG. 1 is a view illustrating an outline of a computer system in accordance with an embodiment 1.

A computer system is provided with a host computer (hereafter referred to as a host) 2 and a storage apparatus 4 that is coupled to a host 2. The host 2 executes a plurality of virtual machines 20. Each of the virtual machines 20 communicates with a terminal 3 of a user. In the shown example, a terminal #1 that is used by a user #1 communicates with a virtual machine #1 and a terminal #2 that is used by a user #2 communicates with a virtual machine #2.

The storage apparatus 4 is provided with a primary volume 15 and a data volume 11. The storage apparatus 4 creates a virtual volume 10 based on the primary volume 15 and the data volume 11 and provides the virtual volume to the host 2. In the following descriptions and figures, the primary volume 15 is abbreviated to P-VOL 15, the data volume 11 is abbreviated to D-VOL 11, and the virtual volume 10 is abbreviated to V-VOL 10 in some cases.

The P-VOL 15 stores master data. The master data can include read-only data. The D-VOL 11 stores write data that is transmitted from the virtual machine 20 to the V-VOL 10. The write data is referred to as update data in some cases in the following. The update data can be data obtained by updating data that has been read from the P-VOL 15 based on the write data, and can also be new write data. At a time point when the V-VOL 10 is provided to the virtual machine 20, the D-VOL 11 has not stored the update data. In the present embodiment, image data is data for providing the virtual machine 20 to the host 2. However, image data is not restricted to the data.

V-VOL 110 is a virtual volume in which image data that is provided to the virtual machine 20 is stored. In the present embodiment, VVOLs #1 to X are provided to virtual machines #1 to X, respectively. Image data is data based on the master data of the virtual machine 20 that is stored into the P-VOL 15 and the update data that is stored into the D-VOL 11. Consequently, a plurality of V-VOLs #1 to X are correlated so as to share the P-VOL 15, and D-VOLs #1 to X are correlated with a plurality of V-VOLs #1 to X, respectively.

In the present embodiment, the storage apparatus 4 manages data in which a read access frequency is larger than a predetermined value among the master data in the P-VOL 15 by a read management area 19 to which a physical storage area separate from the P-VOL 15 is allocated. The read management area 19 includes a high read volume 13 and a middle read volume 17. In the following descriptions and figures, the high read volume 13 is abbreviated to HR-VOL 13 and the middle read volume 17 is abbreviated to MR-VOL 17 in some cases.

Among the master data in the P-VOL 15, data in which a read access frequency from each V-VOL 10 is equal to or larger than a predetermined threshold value (such as a third copy threshold value) is copied into the HR-VOL 13 and managed. In the present embodiment, a dedicated HR-VOL 13 is correlated with each V-VOL 10. In the shown example for instance, the HR-VOL #1 is configured to be dedicated for the V-VOL #1. Consequently, data in which a read access frequency from one corresponded V-VOL 10 is equal to or larger than the third copy threshold value is only stored into each HR-VOL 13.

Among the master data in the P-VOL 15, data in which a read access frequency from each V-VOL 10 is equal to or larger than a predetermined threshold value (such as a first copy threshold value) less than the third copy threshold value is copied into the MR-VOL 17 and managed. In the present embodiment, one or a plurality of V-VOLs 10 share one MR-VOL 17. In the shown example for instance, the V-VOLs #1, #2, #3 to #X share the MR-VOL#1a. Consequently, each MR-VOL 17 stores data in which a read access frequency from at least one V-VOL 10 corresponded is equal to or larger than the first copy threshold value and less than the third copy threshold value. Since the MR-VOL 17 is shared by a plurality of V-VOLs 10 as described above, a much load is applied to the MR-VOL 17 by a read access in some cases. In this case for instance, the storage apparatus 4 creates a duplicate of the MR-VOL 17 and correlates at least one V-VOL 10 of a plurality of V-VOLs 10 that shares the MR-VOL 17 with the MR-VOL of a duplicate destination. In the shown example, an MR-VOL #1b is created as a duplicate of an MR-VOL #1a. The V-VOL #2 is newly corresponded to the MR-VOL #1b.

In the present embodiment, in the case in which a read request to the virtual VOL 10 is issued from the the virtual machine 20, the storage apparatus 4 execute a read access to a volume corresponded to the virtual VOL 10 based on read request and the following area information. In this case, a read access to a volume is executed in the order of the D-VOL 11, the HR-VOL 13, the MR-VOL 17, and the P-VOL 15.

The case in which a certain virtual storage area in the V-VOL 10 is associated with a storage area in the P-VOL 15 is considered here. The area information that indicates associating with the virtual storage area is stored in the storage apparatus 4. In the present embodiment, the area information can be managed by two kinds of information for instance.

A first kind is information of correlating of data between volumes for each of volumes (MR-VOL 17, HR-VOL 13, and P-VOL 15) that are corresponded to the V-VOL 10. In the present embodiment, a placement of a plurality of virtual storage areas in the V-VOL and a placement of a plurality of storage areas in each volume are integrated and managed.

A second kind is information that indicates a state of storage of data for a storage area of volumes (MR-VOL 17, HR-VOL 13, and P-VOL 15) that are corresponded to the V-VOL 10. As described above, the master data is stored in the P-VOL 15. As described above moreover, data is stored in the HR-VOL 13 and the MR-VOL 17 by a read access frequency in some cases. Whether or not data has been stored in the storage area is recognized by a bit map to each storage area or the like.

In the next place, a migration of data of each of volumes (MR-VOL 17, HR-VOL 13, and P-VOL 15) that are corresponded to the V-VOL 10 will be described. In the description, a storage area of the same location of each volume, that is, a storage area to which the same identifier is imparted in each volume is referred to as a target storage area.

The storage apparatus 4 measures a read access frequency to a target storage area of the P-VOL for instance. In the case in which it is determined that a read access frequency to a target storage area is equal to or larger than a first copy threshold value, the storage apparatus 4 copies data of a target storage area to a target storage area of the HR-VOL #1. Moreover, the storage apparatus 4 associates a target storage area of the HR-VOL #1 as substitute for a target storage area of the P-VOL #1 with a virtual storage area of the V-VOL #1.

Moreover, in the case in which it is determined that a read access frequency to a target storage area of the P-VOL is equal to or larger than a predetermined third copy threshold value for instance, the storage apparatus 4 copies data of a target storage area to a target storage area of the MR-VOL #1. Moreover, the storage apparatus 4 associates a target storage area of the MR-VOL #1 as substitute for a target storage area of the P-VOL #1 with a virtual storage area of the V-VOL #1.

In the case in which a target storage area is associated with a target storage area of the HR-VOL 13, data is read from the target storage area of the HR-VOL 13. In the case in which a target storage area is associated with a target storage area of the MR-VOL 15, data is read from the target storage area of the MR-VOL 15. Consequently, a load to the P-VOL 15 due to a read access can be reduced.

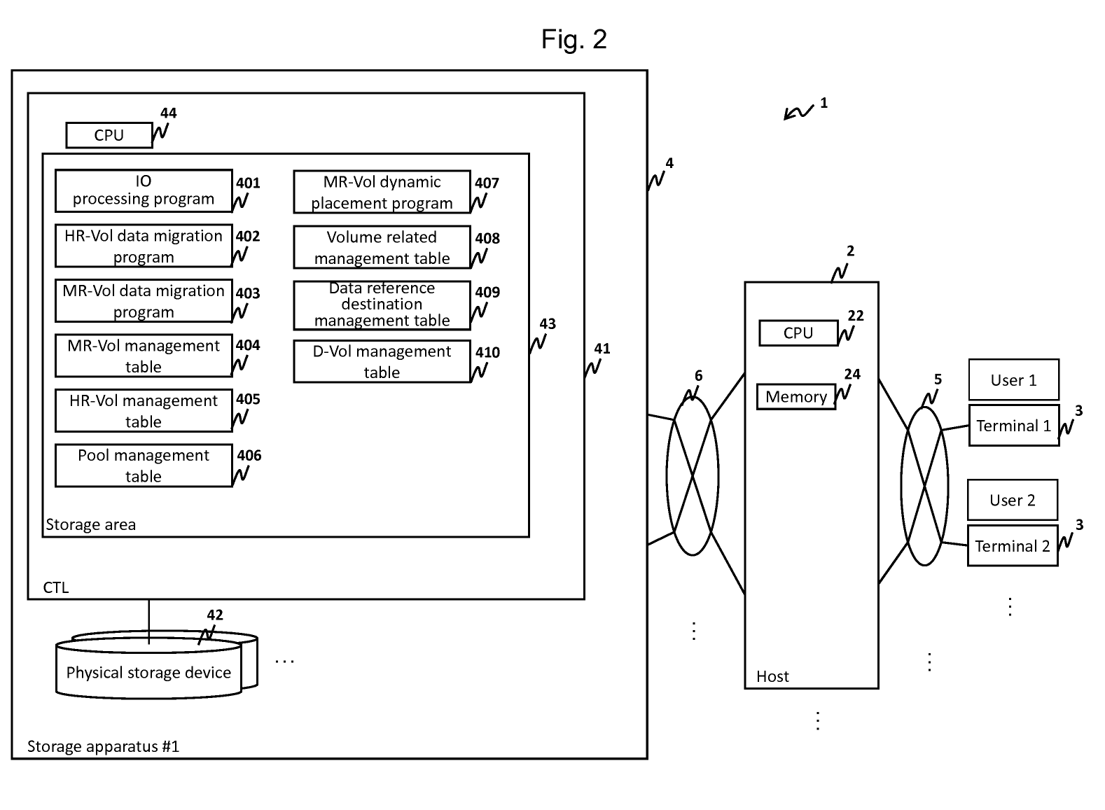

FIG. 2 is an example of a physical block diagram showing of a computer system in accordance with an embodiment 1.

A computer system is provided with a host 2 and a storage apparatus 4. The host 2 is coupled to the storage apparatus 4 via a network 6 such as a SAN (Storage Area Network). Moreover, the host 2 is coupled to a terminal 3 via a network 5 such as a LAN (Local Area Network). The host 2 is provided with a CPU 22 and a memory 24.

The storage apparatus 4 is provided with at least one physical storage device 42 and a controller 41 that is coupled to the physical storage device 42. The physical storage device 42 is a SAS (Serial Attached Small Computer System Interface)-HDD (Hard Disk Drive), a SATA (Serial Advanced Technology Attachment)-HDD, or an SSD (Solid State Drive) for instance, but not restricted to the above devices. As substitute for the physical storage device 42, a semiconductor storage device can also be used. Moreover, a RAID (Redundant Arrays of Inexpensive Disks) group can be configured by a plurality of physical storage devices 42. One or a plurality of volumes (P-VOL 15, HR-VOL 13, MR-VOL 17, and D-VOL 10) can be created by a logical device (LDEV) based on one physical storage device 42 or a plurality of physical storage devices 42 that configure one RAID group, and can be provided to the host 2. At least one physical storage devices 42 can also be provided from an external storage apparatus that is not shown.

In the present embodiment, one volume is based on an LDEV based on one physical storage device 42 or a plurality of physical storage devices 42 that configure one RAID group. However, the present invention is not restricted to the above configuration.

The controller 44 is provided with a processor (such as a Central Processing Unit: CPU) 44 and a storage area 43. The storage area 43 is a memory for instance, and stores a variety of programs that are executed by the CPU 44 and tables. Moreover, the storage area 43 is provided with a cache area (a cache memory) that is not shown. The programs and tables that are stored in the storage area 43 will be briefly described in the following.

An I/O processing program 401 is a program for controlling a read/write of data based on a read access or a write access from a virtual machine 20. An HR-VOL data migration program 402 is a program for copying data of the P-VOL 15 in which a read access frequency is equal to or larger than a predetermined threshold value to the HR-VOL 13. An MR-VOL data migration program 403 is a program for copying data in which a read access frequency is equal to or less than a predetermined threshold value to the MR-VOL 17. An MR-VOL management table 404 is a table for managing a read access frequency of an MR-VOL 404 or the like. An HR-VOL management table 405 is a table for managing a read access frequency of an HR-VOL 405 or the like. A pool management table 406 is a table for managing a performance of a pool 45 or the like. An MR-VOL dynamic placement program 407 is a program for duplicating or deleting the MR-VOL 17. A volume related management table 408 is a table for indicating the correlating with the V-VOL 10. A data reference destination management table 409 is a table for managing information of real data of data of each block or the like as information for every HR-VOL 13 and MR-VOL 17. A D-VOL management table 410 is a table for managing information of real data of data of each block or the like as information for every D-VOL 10.

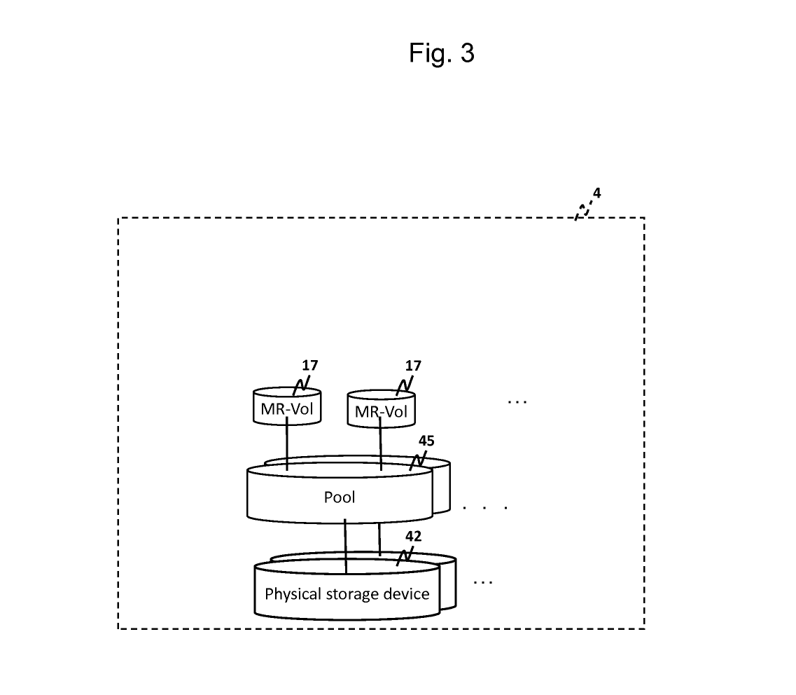

FIG. 3 is a view illustrating a pool 45.

The storage apparatus 4 is provided with a pool 45. The pool 45 is created based on a plurality of physical storage areas of a plurality of physical storage devices 42. In the present embodiment, the MR-VOL 17 is dynamically created by allocating a physical area in the pool 45. That is, at least one MR-VOL 17 belongs to one pool 45. A plurality of pools 45 based on the physical storage device 42 of the same type (drive type) can also exist. In this case, a performance of the pool 45 and a performance of the MR-VOL 17 depend on a performance of the physical storage device 42 in some cases. In the present embodiment, the MR-VOL 17 is dynamically created by utilizing a physical area in the pool 45. However, the HR-VOL 13, D-VOL 11, and P-VOL 15 can also be dynamically created by allocating a physical area in the pool 45.

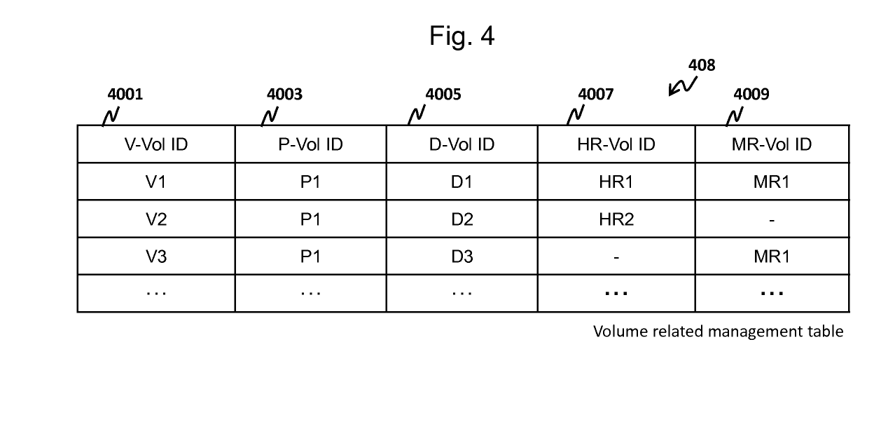

FIG. 4 is a view showing a volume related management table 408.

The volume related management table 408 is provided with an entry for every V-VOL. An entry of a certain V-VOL is provided with a V-VOL ID 4001 that indicates the V-VOL, a P-VOL ID 4003 of a P-VOL that is corresponded to the V-VOL, a D-VOL ID 4005 of a D-VOL that is corresponded to the V-VOL, an HR-VOL ID 4007 of an HR-VOL that is corresponded to the V-VOL, and an MR-VOL ID 4009 of an MR-VOL that is corresponded to the V-VOL. In the case in which an HR-VOL that is corresponded to the V-VOL does not exist, “−” is stored in an HR-VOL ID. In the case in which an MR-VOL that is corresponded to the V-VOL does not exist, “−” is stored in an MR-VOL ID 4009. A volume that belongs to one entry is correlated with other volume that belongs to the entry.

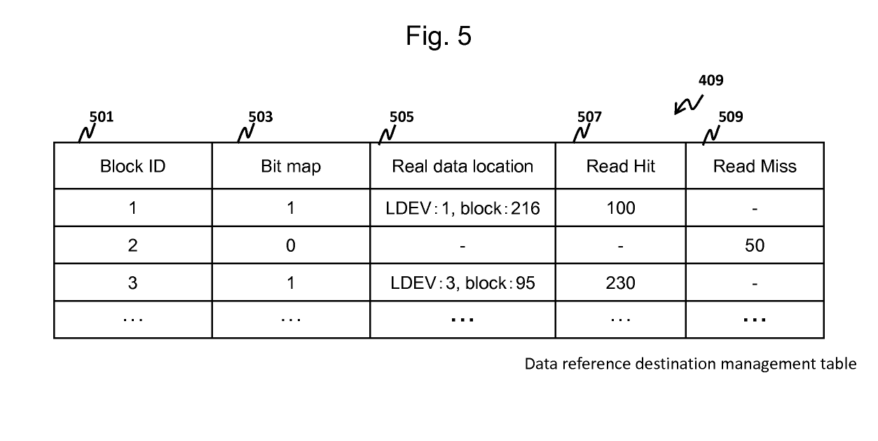

FIG. 5 is a view showing a data reference destination management table 409.

The data reference destination management table 409 is a table that is created for every HR-VOL and MR-VOL. The data reference destination management table 409 is provided with an entry for every block that is included in the corresponded volume. An entry of a certain block is provided with a block ID 501 that indicates the block, a bit map 503 that indicates whether or not valid data has been stored in the block, a real data location 505 that indicates a storage area in a logical device (LDEV) that is a basis of the block, a Read Hit 507 that indicates a count in which real data is read from the block, and a Read Miss 508 that indicates a count in which a valid data has not been stored in the block for a read access to data of the block. The Read Miss 508 can also be a count in which the table 409 has been referred to in a read access to data of the block. For instance, since a bit map of a block 1 is “1”, a valid data has been stored, the real data has been stored in “LDEV: 1, block: 216”, and a value of a read hit is 100. For instance moreover, data has not been stored in a block 2, and a value of a read hit is 50. In the present embodiment as described above, for the block ID 501, the same number (identifier) is imparted to the same location among the P-VOL, D-VOL, and HR-VOL (or MR-VOL) that are corresponded to itself. Consequently, data that has been stored or that will be stored in a block that indicates the same block ID is the same data for itself and the P-VOL, HR-VOL, and MR-VOL that are corresponded to itself. A value of a read hit and a value of a read miss for each block can be measured regularly (every 1 minute for instance) or irregularly for a data migration processing of the R-VOL 13 or a data migration processing of the MR-VOL 17 that are described later. Consequently, a value of a read hit for an arbitrary block is an access frequency of the block for instance.

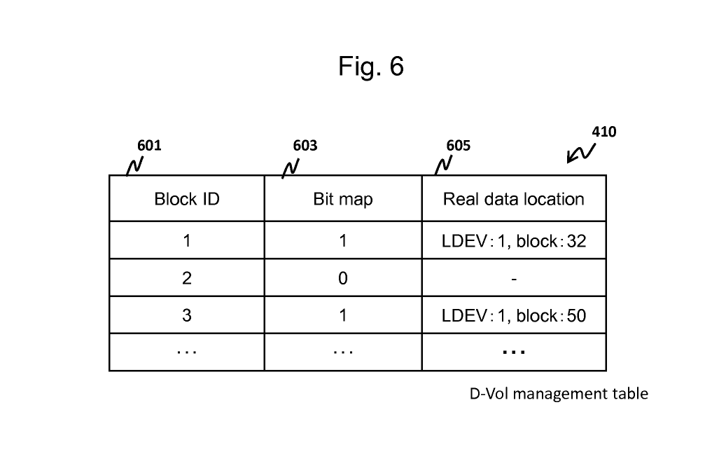

FIG. 6 is a view showing a D-VOL management table 410.

A D-VOL management table 410 is a table that is stored for every D-VOL. The D-VOL management table 410 is provided with an entry for every block that is included in the corresponded volume. An entry of a certain block is provided with a block ID 601 that indicates the block, a bit map 603 that indicates whether or not data has been stored in the block, and a real data location 605 that indicates a storage area in a logical device (LDEV) that is a basis of the block. In the present embodiment as described above, for the block ID 601, the same number is imparted to the same location among the P-VOL, HR-VOL, and MR-VOL that are corresponded to the volume. Consequently, data that has been stored or that will be stored in a block that indicates the same block ID is the update data of the P-VOL, HR-VOL, and MR-VOL that are corresponded to the volume.

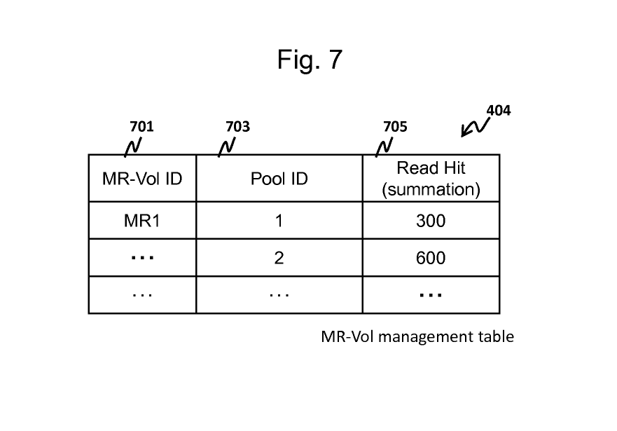

FIG. 7 is a view showing an MR-VOL management table 404.

An MR-VOL management table 404 is provided with an entry for every MR-VOL. An entry of a certain MR-VOL is provided with an MR-VOL ID 701 that indicates the MR-VOL, a pool ID 703 that indicates a pool to which the MR-VOL belongs, and a read hit (summation) 705 that is a total value of a read hit of all blocks of the MR-VOL. A read hit (summation) can be measured regularly or irregularly. For instance, the read hit (summation) can be measured regularly for a dynamic placement processing of the MR-VOL 17 that is described later.

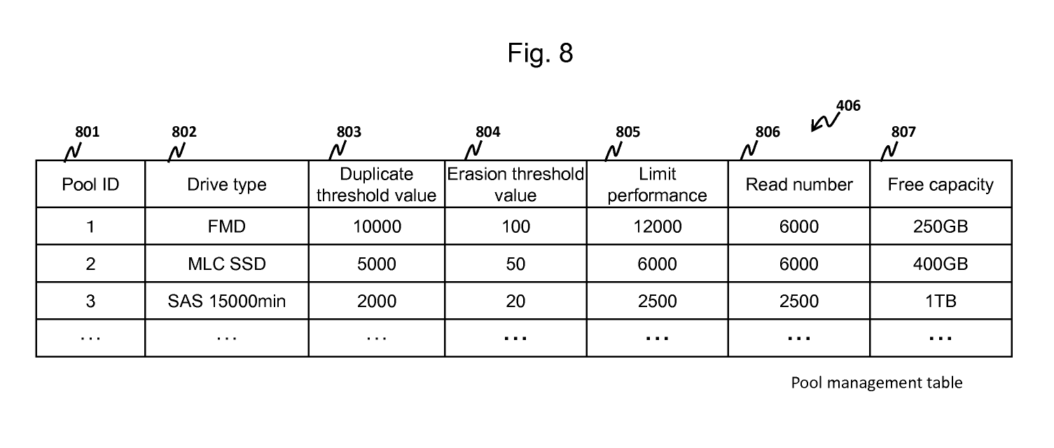

FIG. 8 is a view showing a pool management table 406.

A pool management table 406 is provided with an entry for every pool. An entry of a certain pool is provided with a pool ID 801 that indicates the pool, a drive type 802 that indicates a type of a physical storage device that is a basis of the pool, a duplicate threshold value 803 that is a threshold value of a read access frequency for determining whether or not a duplicate of an MR-VOL that belongs to the pool is created, an erasion threshold value 804 that is a threshold value of a read access frequency for determining whether or not an MR-VOL that belongs to the pool is erased, a limit performance 805 that is a read access frequency that indicates a limit of a load of the pool, a read number 806 that is a total read access frequency to all MR-VOLs that belong to the pool, and a free capacity 807 of the pool. By subtracting the read number 806 from the limit performance 805 for the pool, a free performance that indicates an allowance of a performance of the pool can be computed. The read number 806 can be measured regularly or irregularly. For instance, the read number 806 can be measured regularly for a dynamic placement processing of the MR-VOL 17 that is described later.

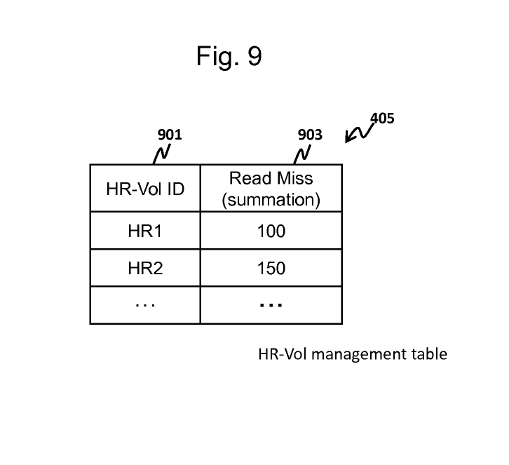

FIG. 9 is a view showing an HR-VOL management table 405.

An HR-VOL management table 405 is provided with an entry for every HR-VOL. An entry of a certain HR-VOL is provided with an HR-VOL ID 901 that indicates the HR-VOL and a read miss (summation) 903 that is a total value of a read miss of all blocks that are included in the HR-VOL. A read miss (summation) 903 can be measured regularly or irregularly. For instance, the read miss (summation) can be measured regularly for a dynamic placement processing of the MR-VOL 17 that is described later.

The processing of the present embodiment will be described in the following. A step of a processing will be described as “S” simply in the following. A bit map will be described as bm in the following descriptions and figures in some cases.

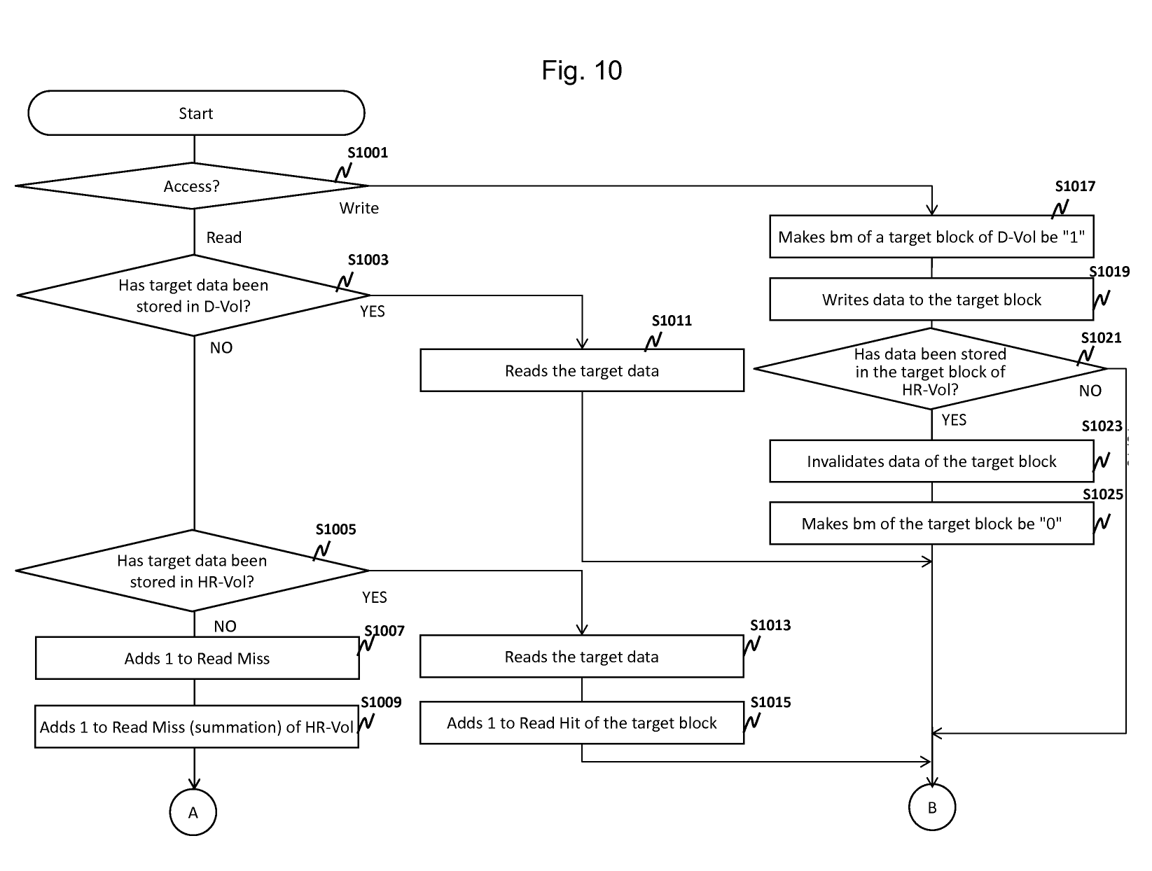

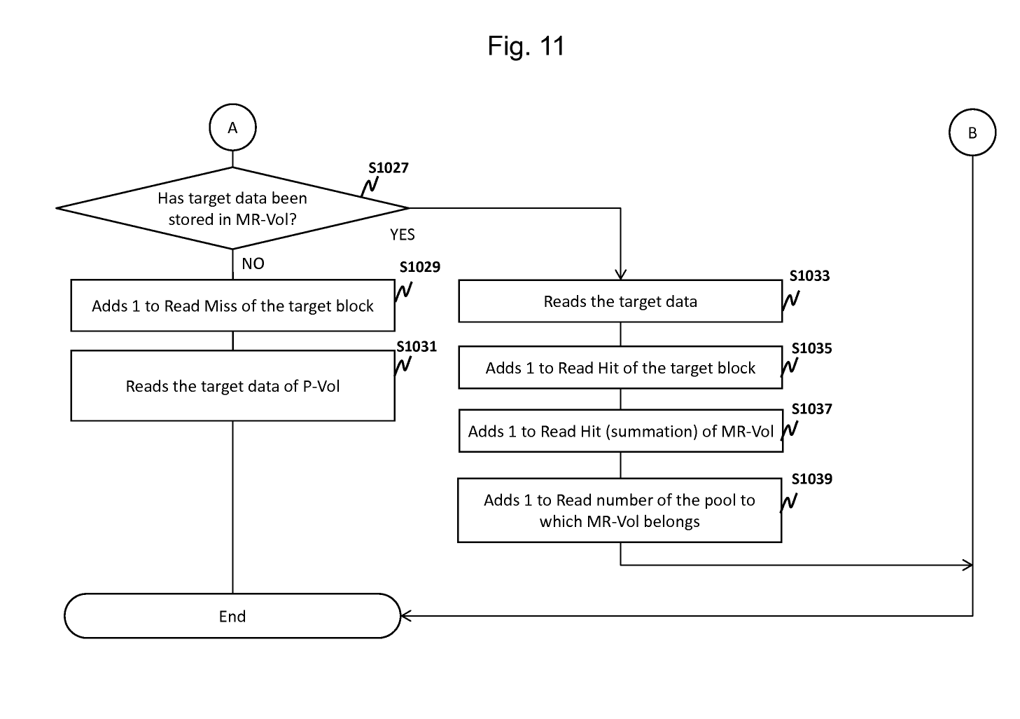

FIG. 10 is a view showing a first-half part of a flowchart of an I/O processing. FIG. 11 is a view showing a second-half part of the flowchart of an I/O processing.

The I/O processing is implemented in the case in which the CPU 44 of the storage apparatus 4 executes the I/O processing program 401. In the case in which an access of the V-VOL 10 occurs from the virtual machine 20, the I/O processing program 401 is initiated. The I/O processing program 401 is simply referred to as a program 401 in the following.

In the step S1001, the program 401 determines whether an access of the target data to the V-VOL 10 is a read access or a write access. Moreover, the program 401 identifies a block address of a block in which the target data that is a target of an access has been stored based on an ID and an address of a V-VOL of an access destination that is included in the access for a volume that is corresponded to the V-VOL. In the following descriptions, a V-VOL of an access destination is referred to as a target V-VOL, and a block of a block ID that has been identified is referred to as a target block.

In the case of a write access (S1001: write), the program 401 refers to the volume related management table 408 and extracts an ID of a D-VOL 11 that is corresponded to the target V-VOL 10. In the step S1017, the program 401 then makes a value of a bit map (bm) 503 of a target block of the D-VOL management table 410 be “1” for the D-VOL 11 that has been extracted. In the step S1019, the program 401 then writes the target data to the target block of the D-VOL 11 that has been extracted. More specifically for instance, the program 401 reads data from the target block of a P-VOL 15 that is corresponded to the target V-VOL to a cache memory not shown for the controller 41. The program 401 then updates data that has been read by the target data and writes the read data as the update data to the target block of the D-VOL 11 that has been extracted. The program 401 can read data from the target block of an HR-VOL 13 or an MR-VOL 17 that is corresponded to the target V-VOL 10 as substitute for the target block of the P-VOL 15. In this case, the program 401 refers to the volume related management table 408 and determines whether or not there is an HR-VOL 13 or an MR-VOL 17 that is corresponded to the target V-VOL 10. In the case in which the HR-VOL 13 or the MR-VOL 17 exists, the program 401 can read data to the cache memory based on the HR-VOL 13 or the MR-VOL 17 and a target block ID.

In the step S1021, the program 401 refers to the data reference destination management table 409 of the HR-VOL 13 that is corresponded to the target V-VOL 10 and determines whether or not valid data has been stored in the target block, that is, a value of the bit map (bm) 503 of a target block is “1”. In the case in which a value of the bit map 503 of a target block is “0” (S1021: No) (B in the figure), the program 401 terminates the processing. On the other hand, in the case in which a value of the bit map 503 of a target block is “1” (S1021: Yes), the program 401 invalidates data of the target block of the corresponded HR-VOL 13 in the step S1023. In this step, data of the target block can be erased or can be erased at another timing. The program 401 then makes a value of the bit map 503 of the target block be “0” for the data reference destination management table 409 of the corresponded HR-VOL 13.

In the case of a read access (S1001: read), the program 401 refers to the volume related management table 408 and extracts an ID of the D-VOL 11, HR-VOL 13, MR-VOL 17, and P-VOL 15 that are corresponded to the target V-VOL 10. In the step S1003, the program 401 determines whether or not valid target data has been stored in the target block of the D-VOL 11 that is corresponded to the target V-VOL 10. More specifically for instance, the program 401 refers to the D-VOL management table 410 and determines whether or not a value of the bit map 603 of a target block is “1”. In the case in which a value of the bit map 603 is “1” (S1003: Yes), it is indicated that the target data has been stored in the target block of the D-VOL 11. Consequently, the program 401 reads the target data of the target block of the D-VOL 11 to the cache memory, transmits the target data to the virtual machine 20 (B in the figure), and terminates the processing.

On the other hand, in the case in which a value of the bit map 603 is “0” (S1003: No), it is indicated that the target data has not been stored in the target block of the D-VOL 11. Consequently, the program 401 then determines whether or not valid target data has been stored in the target block of the HR-VOL 13 that is corresponded to the target V-VOL 10. More specifically for instance, the program 401 refers to the data reference destination management table 409 of the HR-VOL 13 and determines whether or not a value of the bit map 503 of a target block is “1”.

In the case in which a value of the bit map 503 is “1” (S1005: Yes), it is indicated that the target data has been stored in the target block of the HR-VOL 13. Consequently, the program 401 reads the target data of the target block of the HR-VOL 13 to the cache memory and transmits the target data to the virtual machine 20 in the step S1013. In the step S1015, the program 401 then adds 1 to a value of the read hit 507 of the target block of the data reference destination management table 409 (B in the figure), and terminates the processing.

On the other hand, in the case in which a value of the bit map 503 is “1” (S1005: No), it is indicated that the target data has not been stored in the target block of the HR-VOL 13. Consequently, the program 401 adds 1 to a value of the read miss 509 of the target block for the data reference destination management table 409 of the HR-VOL 13 in the step S1007. In the step S1009, the program 40 then adds 1 to a value of the read miss (summation) 405 of the HR-VOL management table 405 (A in the figure), and goes ahead with the processing to the step S1027.

The FIG. 11 will be described in the following. In the step S1027, the program 401 determines whether or not valid target data has been stored in the target block of the MR-VOL 17 that is corresponded to the target V-VOL 10. More specifically for instance, the program 401 refers to the data reference destination management table 409 of the MR-VOL 17 and determines whether or not a value of the bit map 603 of a target block is “1”. In the case in which a value of the bit map 603 is “1” (S1027: Yes), it is indicated that the target data has been stored in the target block of the MR-VOL 17. Consequently, the program 401 reads the target data of the target block of the MR-VOL 17 to the cache memory and transmits the target data to the virtual machine 20 in the step S1033.

In the step S1035, the program 401 adds 1 to a value of the read hit of the target block for the data reference destination management table 409 of the MR-VOL 17.

In the step S1037, the program 40 then adds 1 to a value of the read hit (summation) 705 of the MR-VOL 17 for the MR-VOL management table 404. Moreover, in the step S1039, the program 401 refers to the MR-VOL management table 404, extracts a pool ID 703 that is corresponded to the MR-VOL 11, adds 1 to the read number 806 of the pool management table 406 for the extracted pool, and terminates the processing.

On the other hand, in the case in which a value of the bit map 603 is “0” (S1027: No), it is indicated that the target data has not been stored in the target block of the MR-VOL 17. Consequently, the program 401 adds 1 to a value of the read miss 509 of the target block for the data reference destination management table 409 of the MR-VOL 17 in the step S1029. In the step S1031, the program 401 reads the target data of the target block of the P-VOL 15 that is corresponded to the target V-VOL 101 to the cache memory and transmits the target data to the virtual machine 20.

By the above processing, in the case in which a read request is issued to the target data of the target V-VOL from the virtual machine 20, the program 401 can read the target data from other volume without a read access to the P-VOL 15 that is corresponded to the target V-VOL 15 for a target block in which a read access frequency is high. More specifically, in the I/O processing of the present embodiment, it is determined that whether or not target data has been stored in a target block in the order of the D-VOL 11, HR-VOL 13, MR-VOL 17, and P-VOL 15 for the target block. Consequently, in the case in which the target data has already been updated, the target data is read from the D-VOL 15 that is corresponded to the target V-VOL 15. In the case in which the target data has not been stored in the D-VOL 15 and has been stored in the HR-VOL 13 that is corresponded to the target V-VOL 15, the target data is read from the HR-VOL 13. Moreover, in the case in which the target data has not been stored in the D-VOL 15 and the HR-VOL 13 and has been stored in the HR-VOL 13 that is corresponded to the target V-VOL 15, the target data is read from the MR-VOL 17. In the case in which the target data has not been stored in the D-VOL 15, the HR-VOL 13, and the MR-VOL 17, the target data is read from the P-VOL 15. By this configuration, by modifying a read access destination of the target data to be a volume other than the P-VOL, a load caused by a read access for the P-VOL 15 can be reduced.

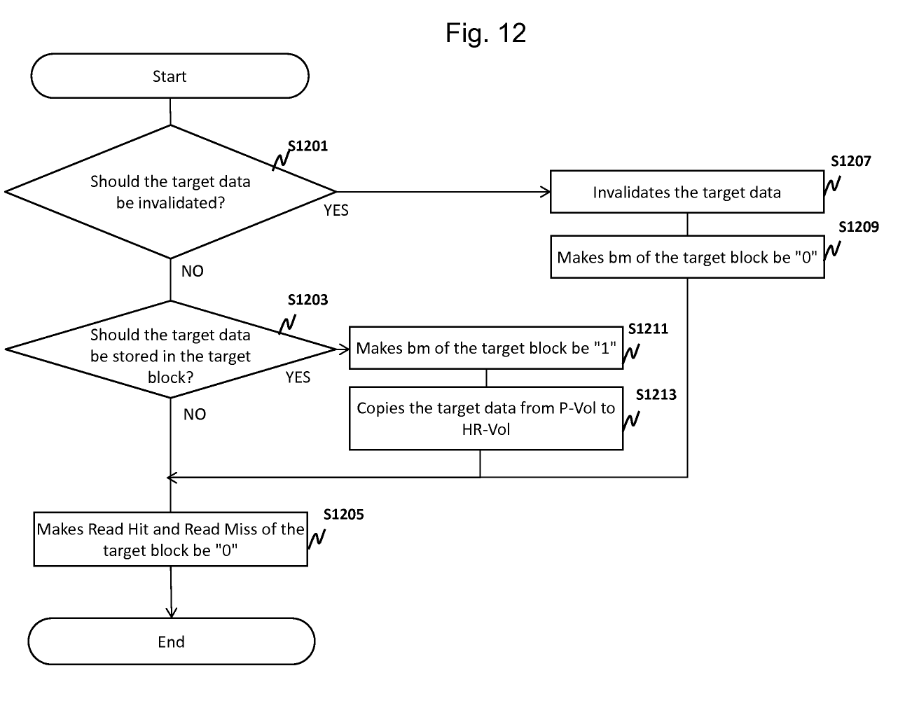

FIG. 12 is a flowchart of a data migration processing of the HR-VOL 13.

The data migration processing of the HR-VOL 13 is implemented in the case in which the CPU 44 of the storage apparatus 4 executes the HR-VOL data migration program 402. The HR-VOL data migration program 402 is simply referred to as a program 402 in the following. In the present embodiment, the program 402 is executed regularly (every 1 minute for instance) according to a predetermined order to all blocks of all HR-VOLs 13 that are included in the storage apparatus 4. However in other example, the program 402 can also be executed irregularly in no particular order to all blocks of all HR-VOLs 13 that are included in the storage apparatus 4. Moreover, the program 402 can also be executed after the I/O processing to each block is executed. In the following, an arbitrary block of an arbitrary HR-VOL 13 to which the processing is executed is referred to as a target HR-VOL 13 and a target block. Moreover, data that has been stored or that will be stored in a target block of a target HR-VOL 13 is referred to as target data.

In the step S1201, the program 402 determines whether or not the target data that has been stored in the target block of the target HR-VOL 13 is invalidated. In this determination, in the case in which valid target data has been stored in the target block and a read access frequency of the target block of the target HR-VOL 13 is less than a predetermined threshold value (an HR read hit threshold value), the target data is erased. More specifically, the program 402 refers to the data reference destination management table 409 of the target HR-VOL 13. In the case in which a value of the bit map 503 of the target data is “1” and a value of a read hit 507 is less than the HR read hit threshold value (S1201: Yes), the program 402 goes ahead with the processing to the step S1207. In the other case (S1201: No), the program 402 goes ahead with the processing to the step S1203.

In the step S1207, the program 402 invalidates the target data of the target block of the target HR-VOL 13. The program 402 can erase the target data at this time or can erase the target data at another timing. In the step S1209, the program 402 then makes a value of the bit map 503 of the target block be “0” for the data reference destination management table 409 of the target HR-VOL 13, and terminates the processing. An erasion of the target data (S1207) can be executed at any timing.

In the step S1203, the program 402 determines whether or not the target data is stored in the target block. This determination is executed in the case in which data has not been stored in the target block, that is, the target block is a free block and a read access frequency to the target block of the MR-VOL 17 or the P-VOL 15 that is corresponded to the target HR-VOL 13 is equal to or larger than a predetermined threshold value (an HR read miss threshold value). More specifically, the program 402 refers to the data reference destination management table 409 of the target HR-VOL 13. In the case in which a value of the bit map 503 of the target data is then “0” and a value of a read miss 509 of the target block is equal to or larger than the HR read miss threshold value (S1203: Yes), the program 402 goes ahead with the processing to the step S1211. In the other case (S1203: No), the program 402 goes ahead with the processing to the step S1205.

In the step S1211, the program 402 makes a value of the bit map 503 of the target block be “1” for the data reference destination management table 409 of the target HR-VOL 13. In the step S1213, the program 402 refers to the volume related management table 408, identifies the P-VOL 15 that is corresponded to the target HR-VOL 13, and copies the target data of the target block of the identified P-VOL 15 to the target block of the target HR-VOL 13.

In the step S1205, the program 402 makes a value of the read hit 507 of the target block be “0” and makes a value of the read miss 509 of the target block be “0” for the data reference destination management table 409 of the target HR-VOL 13. Here, the values of the read hit and the read miss of the target block for the data reference destination management table 409 of the target HR-VOL 13 are initialized. In the present embodiment, since the program 402 executes the processing regularly (every 1 minute for instance) as described above, a value of the read hit 507 and a value of the read miss 509 of the target block are a value at regular time intervals (a read access frequency), respectively.

In the above processing, in the case in which a read access frequency to the target block of the MR-VOL 17 or the P-VOL 15 that is corresponded to the HR-VOL 13 (that is, a value of a read miss to the target block of the HR-VOL) is equal to or larger than a predetermined threshold value (an HR read miss threshold value) for an arbitrary free block of an arbitrary HR-VOL 13, the target data of the target block of the P-VOL 15 that is corresponded to the HR-VOL 13 is copied to the free block. By this configuration, for the target block in which a read access frequency to the target block of the MR-VOL 17 and the P-VOL 15 that are corresponded to the HR-VOL 13 is equal to or larger than the HR read miss threshold value, the HR-VOL 13 is also provided with the target data of the P-VOL 15. In the above I/O processing, since the determination of whether or not the target data exists in the target block is executed for the HR-VOL 13 earlier than the P-VOL 15, a read access is executed to the HR-VOL 13 as substitute for the P-VOL 15, and a load of the P-VOL can be reduced.

In the above processing, in the case in which a read access frequency of the target block in which arbitrary data of an arbitrary HR-VOL 13 has been stored is less than a predetermined threshold value (an HR read hit threshold value), the target data is invalidated. By this configuration, the target data in which a read access frequency is less than the HR read hit threshold value is invalidated from the HR-VOL 13, and the capacity efficiency of a storage area can be improved.

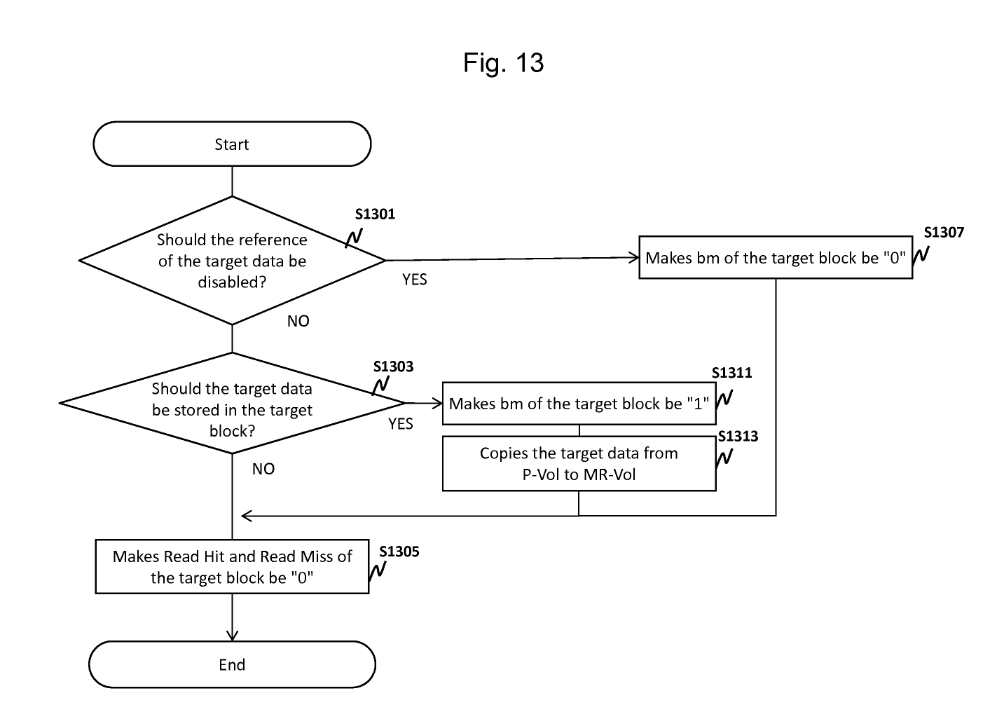

FIG. 13 is a flowchart of a data migration processing of an MR-VOL 17.

The data migration processing of the MR-VOL 17 is implemented in the case in which the CPU 44 of the storage apparatus 4 executes the MR-VOL data migration program 403. The MR-VOL data migration program 403 is simply referred to as a program 403 in the following. In the present embodiment, the program 403 is executed regularly (every 1 minute for instance) according to a predetermined order to all blocks of all MR-VOLs 17 that are included in the storage apparatus 4. However in other example, the program 403 can also be executed irregularly in no particular order to all blocks of all HR-VOLs 13 that are included in the storage apparatus 4. Moreover, the program 403 can also be executed after the I/O processing to each block is executed. In the following, an arbitrary block of an arbitrary MR-VOL 17 to which the processing is executed is referred to as a target MR-VOL 17 and a target block. Moreover, data that has been stored or that will be stored in a target block is referred to as target data.

In the step S1301, the program 403 determines whether or not the reference of the V-VOL 10 of the target data that has been stored in the target block of the MR-VOL 17 is disabled. In this determination, in the case in which valid target data has been stored in the target block of the MR-VOL 17 and a read access frequency of the target block is less than a predetermined threshold value (an MR read hit threshold value), the reference of the target data is disabled. More specifically, the program 403 refers to the data reference destination management table 409 of the target MR-VOL 17. In the case in which a value of the bit map 503 of the target data is “1” and a value of a read hit 507 is less than the MR read hit threshold value (S1301: Yes), the program 403 goes ahead with the processing to the step S1307. In the other case (S1301: No), the program 403 goes ahead with the processing to the step S1303.

In the step S1307, the program 403 disables the reference of the target block of the target MR-VOL 17. For instance, the program 403 makes a value of the bit map 503 of the target block be “0” for the data reference destination management table 409 of the target MR-VOL 17, invalidates the target data of the target block, and terminates the processing. The target data of the target block can be erased in this step or can be erased at another timing.

In the step S1303, the program 403 determines whether or not the target data is stored in the target block that is a free block. This determination is executed in the case in which data has not been stored in the target block, that is, the target block is a free block and a read access frequency to the target block of the P-VOL 15 that is corresponded to the target MR-VOL 10 is equal to or larger than a predetermined threshold value (an MR read miss threshold value). More specifically, the program 403 refers to the data reference destination management table 409 of the target MR-VOL 17. In the case in which a value of the bit map 503 of the target data is then “0” and a value of a read miss 509 of the target block is equal to or larger than the MR read miss threshold value (S1303: Yes), the program 403 goes ahead with the processing to the step S1311. In the other case (S1303: No), the program 403 goes ahead with the processing to the step S1305.

In the step S1311, the program 403 makes a value of the bit map 503 of the target block be “1” for the data reference destination management table 409 of the target MR-VOL 17. In the step S1313, the program 403 then refers to the volume related management table 408, extracts the P-VOL 15 that is corresponded to the target MR-VOL 17, and copies the target data of the target block of the extracted P-VOL 15 to the target block of the target MR-VOL 13.

In the step S1305, the program 403 makes a value of the read hit 507 of the target block be “0” and makes a value of the read miss 509 of the target block be “0” for the data reference destination management table 409 of the target MR-VOL 17. Here, the values of the read hit and the read miss of the target block for the data reference destination management table 409 of the target MR-VOL 17 are initialized. In the present embodiment, since the program 403 executes the processing regularly (every 1 minute for instance) as described above, a value of the read hit 507 and a value of the read miss 509 of the target block are a value at regular time intervals (a read access frequency), respectively.

In the above processing, for an arbitrary free block of an arbitrary MR-VOL 17, in the case in which a read access frequency to the target block of the P-VOL 15 that is corresponded to the MR-VOL 13 (that is, a value of a read miss of the target block of the MR-VOL 13) is equal to or larger than a predetermined threshold value (an MR read miss threshold value), the data of the block of the corresponded P-VOL is copied to the free block. By this configuration, in the above I/O processing, since a read access is executed to the MR-VOL as substitute for the P-VOL for the data in which a read access frequency is equal to or larger than the MR read miss threshold value, a load of the P-VOL can be reduced.

In the above processing, in the case in which a read access frequency to the target block of the target MR-VOL 10 is less than a predetermined threshold value (an MR read hit threshold value) for an arbitrary block in which arbitrary data of an arbitrary MR-VOL 13 has been stored, the target data is erased. By this configuration, the data of the block in which a read access frequency is less than the MR read hit threshold value is included in only the P-VOL 13. Consequently, unnecessary data is erased, whereby the capacity efficiency of a storage area can be improved.

In the present embodiment, the HR read miss threshold value is a value larger than the MR read miss threshold value, and the HR read hit threshold value is a value less than the MR read hit threshold value. By configuring each threshold value as described above, hierarchization is executed on the basis of a read access frequency of the target block in which the target data is stored, whereby a load due to a read access to the target data can be distributed to each of volumes (P-VOL 15, D-VOL 11, HR-VOL 13, and MR-VOL 17).

In the present embodiment, the determination of whether or not the target data is stored in the target block that is a free block (S1303) is executed on the basis of whether or not a read access frequency to the target block of the P-VOL 15 that is corresponded to the target MR-VOL 10 is equal to or larger than the MR read miss threshold value. However, the present invention is not restricted to the configuration. For instance, the determination can also be executed on the basis of whether or not a read access frequency to the target block of the P-VOL 15 that is corresponded to the target MR-VOL 10 is equal to or larger than the MR read miss threshold value and less than the HR read miss threshold value.

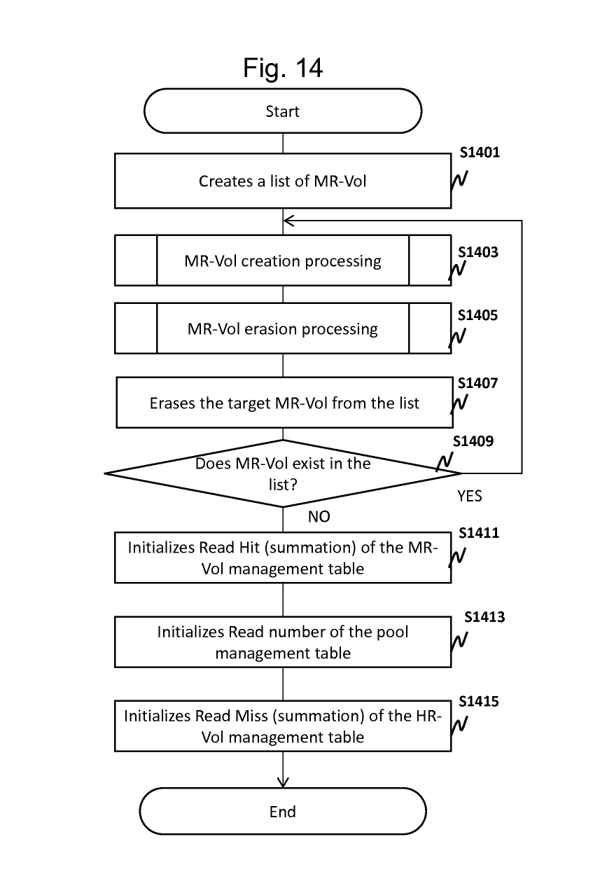

FIG. 14 is a flowchart of a dynamic placement processing of an MR-VOL 17.

The dynamic placement processing of the MR-VOL 17 is implemented in the case in which the CPU 44 of the storage apparatus 4 executes the MR-VOL dynamic placement program 407. The MR-VOL dynamic placement program 407 is simply referred to as a program 407 in the following. In the present embodiment, the program 407 is executed to all blocks of all MR-VOLs 17 that are included in the storage apparatus 4. In the present embodiment, the program 407 is executed regularly at intervals longer than those of the HR-VOL data migration program 402 and the MR-VOL data migration program 403 described above (every 1 hour for instance). However, the program 407 can also be executed irregularly. In the following, an arbitrary block of an arbitrary HR-VOL 13 to which the processing is executed is referred to as a target HR-VOL 13 and a target block. Moreover, data that has been stored or that will be stored in a target block is referred to as target data.

In the step S1401, the program 407 refers to the MR-VOL management table 404 and creates a first MR-VOL list that lists all MR-VOLs 17 that are included in the storage apparatus 4.

The program 407 selects an arbitrary MR-VOL 17 of the storage apparatus 4 from the first MR-VOL list and makes it be a target MR-VOL. In the step S1403, the program 407 then executes an MR-VOL creation processing for the target MR-VOL. This processing will described later.

In the step S1405, the program 407 executes an MR-VOL erasion processing for the target MR-VOL. This processing will be described later.

In the step S1407, the program 407 erases the target MR-VOL from the first MR-VOL list.

In the step S1409, the program 407 determines whether or not an MR-VOL exists in the first MR-VOL list. In the case in which the MR-VOL 17 exists in the first MR-VOL list (S1409: Yes), the program 407 newly selects an arbitrary MR-VOL as the target MR-VOL, and returns the processing to the step S1403. On the other hand, in the case in which the MR-VOL 17 does not exist in the first MR-VOL list, that is, all MR-VOLs have been erased from the first MR-VOL list (S1409: No), the program 407 goes ahead with the processing to the step S1411.

In the step S1411, the program 407 makes (initializes) a value of the read hit (summation) 705 of all MR-VOLs 17 of the MR-VOL management table 404 to be 0.

In the step S1413, the program 407 refers to the MR-VOL management table 404 and identifies all pools that are corresponded to all MR-VOLs 17. The program 407 then makes (initializes) a value of the read number 806 of the pool management table 406 to be 0 for the identified pool.

In the step S1415, the program 407 refers to the MR-VOL management table 404 and the volume related management table 408, and identifies all HR-VOLs 13 that are corresponded to all MR-VOLs 17. The program 407 then makes (initializes) a value of the read miss (summation) 903 of the HR-VOL management table 405 to be 0 for the identified HR-VOL 13.

By the above processing, a creation and an erasion depending to a load can be executed for all MR-VOLs 17 that are included in the storage apparatus 4.

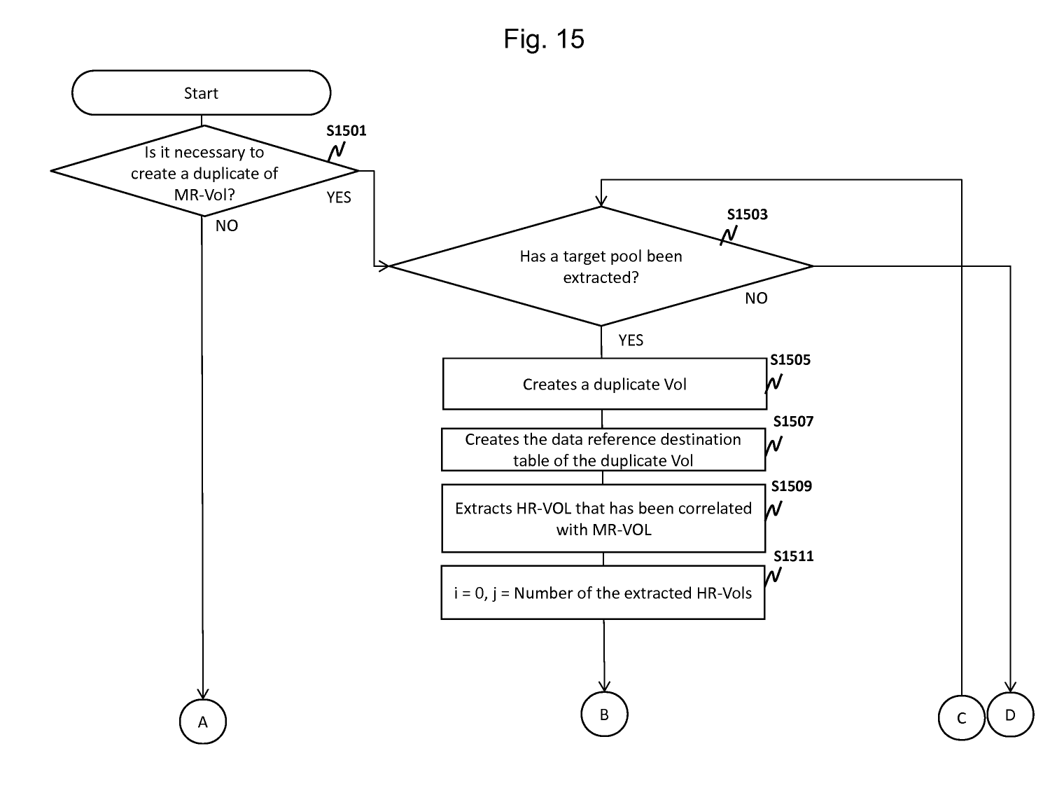

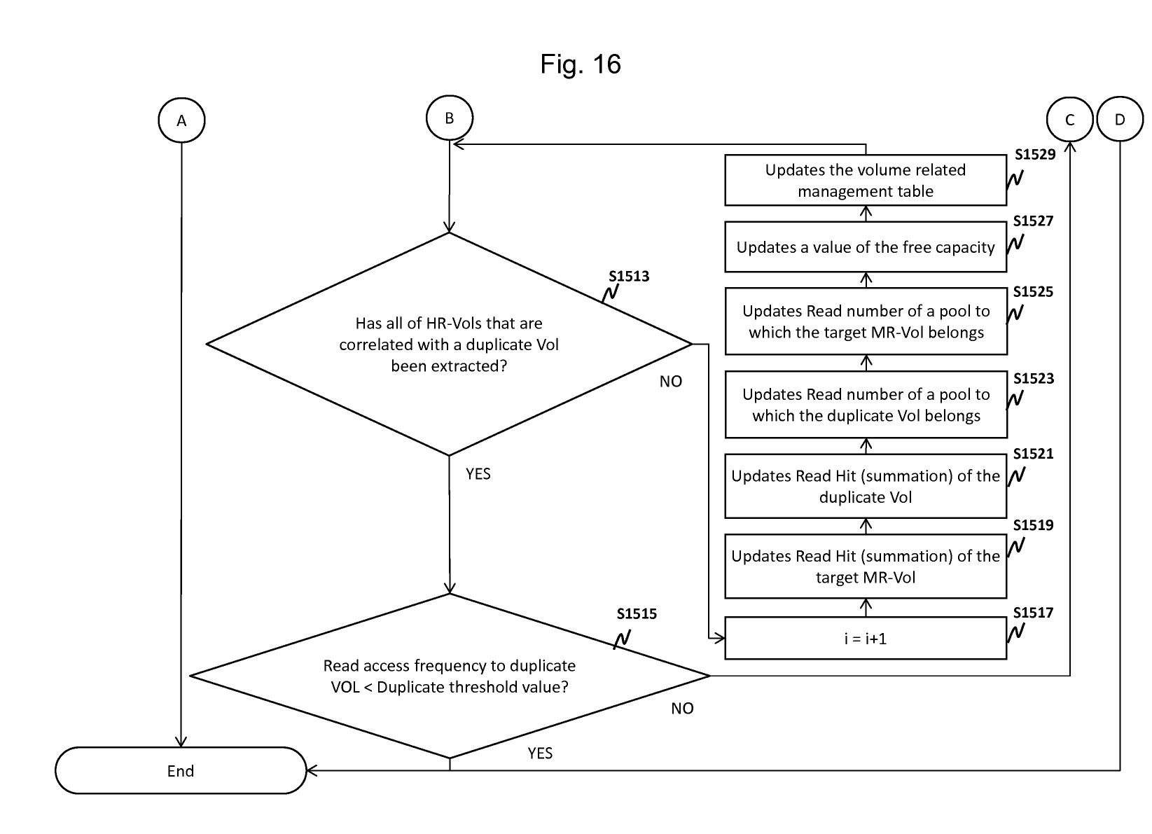

FIG. 15 is a view showing a first-half part of a flowchart of an MR-VOL creation processing. FIG. 16 is a view showing a second-half part of a flowchart of an MR-VOL creation processing.

The MR-VOL creation processing is a processing of the step S1403 of the dynamic placement processing of the MR-VOL 17. As described above, an MR-VOL that is a target of this processing is referred to as a target MR-VOL.

In the step S1501, the program 407 determines whether or not it is necessary to create a duplicate of the target MR-VOL 17. In this determination, it is determined that it is necessary to create a duplicate in the case in which a total value of a read access frequency to all blocks of the target MR-VOL 17 is equal to or larger than a predetermined threshold value (a duplicate threshold value). More specifically for instance, the program 407 refers to the MR-VOL management table 404 and the pool management table 406. In the case in which a value of the read hit (summation) 705 of the target MR-VOL is then equal to or larger than the duplicate threshold value 803 of a pool to which the target MR-VOL belongs (S1501: Yes), the program 407 goes ahead with the processing to the step S1503. On the other hand, in the case in which a value of the read hit (summation) 705 of the target MR-VOL is less than the duplicate threshold value 803 of a pool to which the target MR-VOL belongs (S1501: No) (A in the figure), the program 407 terminates the processing.

In the step S1503, in the case in which the program 407 creates a duplicate VOL of the target MR-VOL 17, the program 407 determines whether or not a target pool that is a pool suitable for the duplicate VOL belonging to the pool has been extracted. More specifically for instance, the program 407 can refer to the pool management table 406 and can increase a load. In other words, a target pool that is a pool in which a free performance has an allowance and that is a pool in which a free capacity is sufficient is extracted. In this case for instance, for the extraction of a target pool, the program 407 can also compute a value obtained by subtracting the read number 806 from the limit performance 805 of the pool management table 406 as a free performance value for every pool, extract a pool in which the free capacity 807 is equal to or larger than a predetermined threshold value in an order from a pool provided with a higher free performance value, and make a pool that has been extracted earliest be a target pool. In the case in which a target pool has been extracted (S1503: Yes), the program 407 goes ahead with the processing to the step S1505. On the other hand, in the case in which a target pool has not been extracted (S1503: No) (D in the figure), the program 407 terminates the processing.

In the step S1505, the program 407 creates a duplicate VOL of the target MR-VOL 17 to the target pool. More specifically for instance, the program 407 imparts a new MR-VOL ID to the duplicate VOL, correlates the VOL with the target pool, and registers the VOL to the MR-VOL management table 404.

In the step S1507, the program 407 creates a duplicate of the data reference destination management table 409 of the target MR-VOL 17, and registers the duplicate as the data reference destination management table 409 of the duplicate VOL.

In the step S1509, the program 407 refers to the volume related management table 408, extracts all of the HR-VOLs 13 that have been correlated with the target MR-VOL 17, and rearranges the extracted HR-VOLs 13 in an order from the larger value of the read miss (summation) based on the HR-VOL management table 405. At this time, for the HR-VOL management table 405, the extracted HR-VOLs 13 can be rearranged, or a list of the extracted HR-VOLs 13 can also be created.

In the step S1511, the program 407 configures 0 to a variable i. Moreover, the program 407 configures the number of the HR-VOL 13 that has been extracted in the step S1509 to a constant j.

The FIG. 16 will be described in the following. The program 407 identifies the extracted HR-VOL 13 of which a value of a read miss (summation) is highest as a target HR-VOL 13 that is correlated with a duplicate VOL. In the step S1513, the program 407 determines whether or not all of target HR-VOLs 13 that are correlated with a duplicate VOL has been identified. In this determination for instance, in the case in which the correlating of the target MR-VOL 17 for the HR-VOL 13 is disabled, a read access frequency to the target MR-VOL 17 is less than the duplicate threshold value, or in the case in which a candidate of the next target HR-VOL 13 does not exist, all of target HR-VOLs 13 that are correlated with a duplicate VOL has been identified (S1513: Yes). More specifically for instance, the program 407 refers to the MR-VOL management table 404, the HR-VOL management table 405, and the pool management table 406. In the case in which a value obtained by subtracting a value of a read miss (summation) of the target HR-VOL 17 from a value of a read hit (summation) of the target MR-VOL 17 is less than the duplicate threshold value of the target MR-VOL 17 or i=(j−1) (S1513: Yes), the program 407 goes ahead with the processing to the step S1515. In the other case (S1513: No), the program 407 goes ahead with the processing to the step S1529.

In the step S1515, the program 407 determines whether or not a read access frequency that is predicted to the duplicate VOL is less than the duplicate threshold value. More specifically for instance, the program 407 makes all of target HR-VOLs 17 that have been identified in the step S1513 be a duplicate destination HR-VOL 17 and refers to the HR-VOL management table 405, and determines whether or not a duplicate destination read miss value that is a value of a read miss (summation) 903 of the duplicate destination HR-VOL 17 is less than the duplicate threshold value of the target MR-VOL 17. As a result of the determination of the step S1515, in the case in which a duplicate destination read miss value is less than the duplicate threshold value (S1515: Yes), the program 407 terminates the processing. On the other hand, in the case in which a duplicate destination read miss value is equal to or larger than the duplicate threshold value (S1515: No) (C in the figure), the program 407 returns the processing to the step S1503.

In the step S1517, the program 407 adds 1 to a value of a variable i. In the step S1519, the program 407 updates a read hit (summation) of the target MR-VOL 17. For instance, the program 407 configures a value obtained by subtracting a value of a read miss (summation) of the target HR-VOL 17 from a value of a read hit (summation) of the target MR-VOL 17 as a value of a read hit (summation) of the target MR-VOL 17. The program 407 then updates the MR-VOL management table 404 by this value.

In the step S1521, the program 407 updates a read hit (summation) of the duplicate VOL. For instance, the program 407 updates a value of a read hit (summation) of the MR-VOL management table 404 for the duplicate VOL to be a value obtained by adding a value of a read miss (summation) of the target HR-VOL 17 to the value.

In the step S1523, the program 407 updates a value of the read number 806 of a pool (a target pool) to which the duplicate VOL belongs for the pool management table 406 to be a value obtained by adding a value of a read miss (summation) of the target HR-VOL 17 to the value.

In the step S1525, the program 407 updates a value of the read number 806 of a pool to which the target MR-VOL belongs for the pool management table 406 to be a value obtained by subtracting a value of a read miss (summation) of the target HR-VOL 17 from the value.

In the step S1527, the program 407 updates a value of the free capacity 807 of the pool management table 406. More specifically for instance, the program 407 makes a value of the free capacity 807 of a pool to which the target MR-VOL belongs be a value obtained by subtracting a value of a capacity of the target HR-VOL from the value, and updates a value of the free capacity 807 of a pool (a target pool) to which the duplicate VOL belongs to be a value obtained by adding a value of a capacity of the target HR-VOL to the value. A value of a capacity of the target HR-VOL can also be a value obtained by multiplying the number of blocks in which the bit map 603 of the data reference destination management table 409 of the target HR-VOL is “1” by a capacity of the block.

In the step S1529, the program 407 updates the volume related management table 408. More specifically for instance, the program 407 updates a field of the MR-VOL ID 409 that is corresponded to the target HR-VOL by an ID of the duplicate VOL.

In the above processing, for the MR-VOL (the target MR-VOL) 17 in which a read access frequency is equal to or larger than a predetermined threshold value (a duplicate threshold value), the duplicate VOL thereof can be created, and a part or a whole of the HR-VOLs 13 that have been correlated with the target MR-VOL 17 can be correlated with the duplicate VOL. By this configuration, a load due to a read access to the target MR-VOL 17 can be distributed to the duplicate VOL.

Moreover, in the case in which a plurality of HR-VOLs 13 have been correlated with the target MR-VOL 17, the new correlating of an HR-VOL 17 with the duplicate VOL is executed in an order from an HR-VOL 17 in which a read access frequency is higher, that is, an HR-VOL 17 in which a read miss (summation) to a read access to each block is higher. By this configuration, a load due to a read access to the target MR-VOL 17 can be efficiently reduced.

In the above processing, a pool is extracted based on a free performance and a free capacity for every pool and the duplicate VOL is created so as to belong to the pool. By this configuration, in the case in which the duplicate VOL is dynamically created, the efficiency of a performance and a capacity of the physical storage device 42 that is a basis of each pool can be promoted.

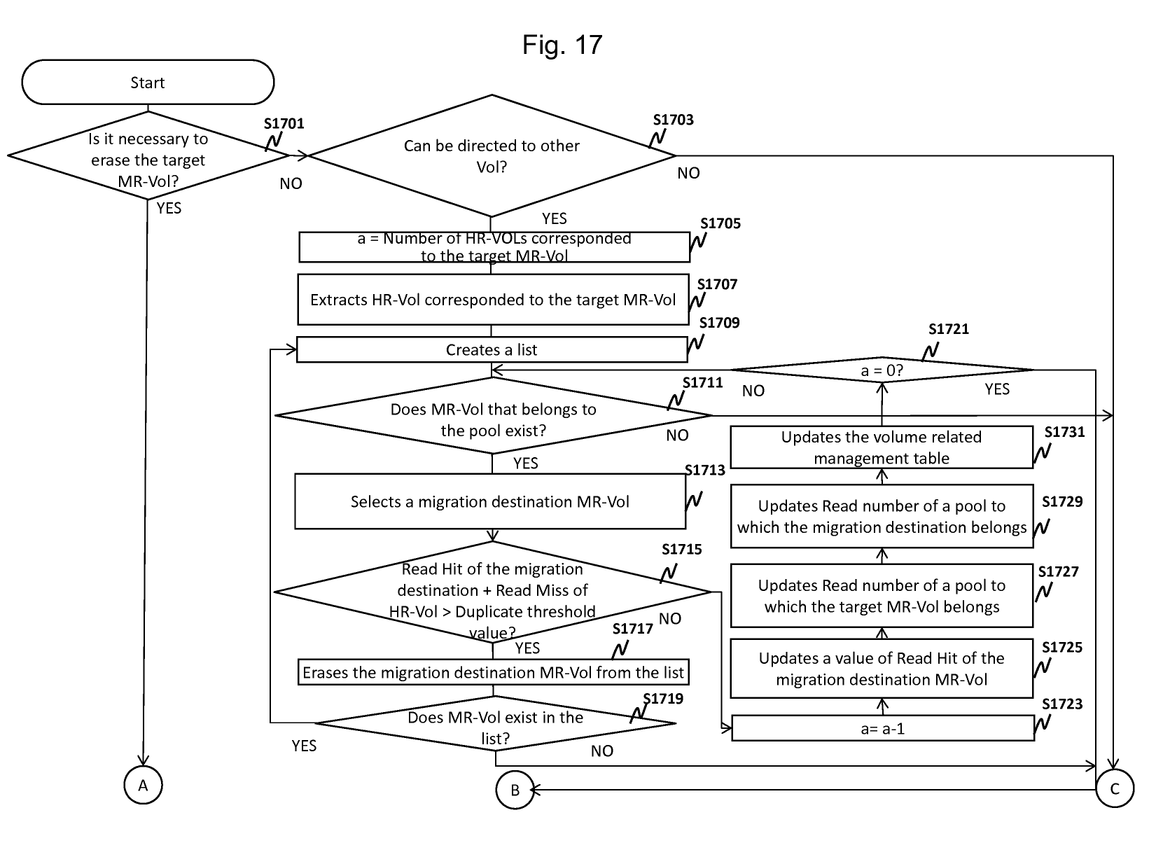

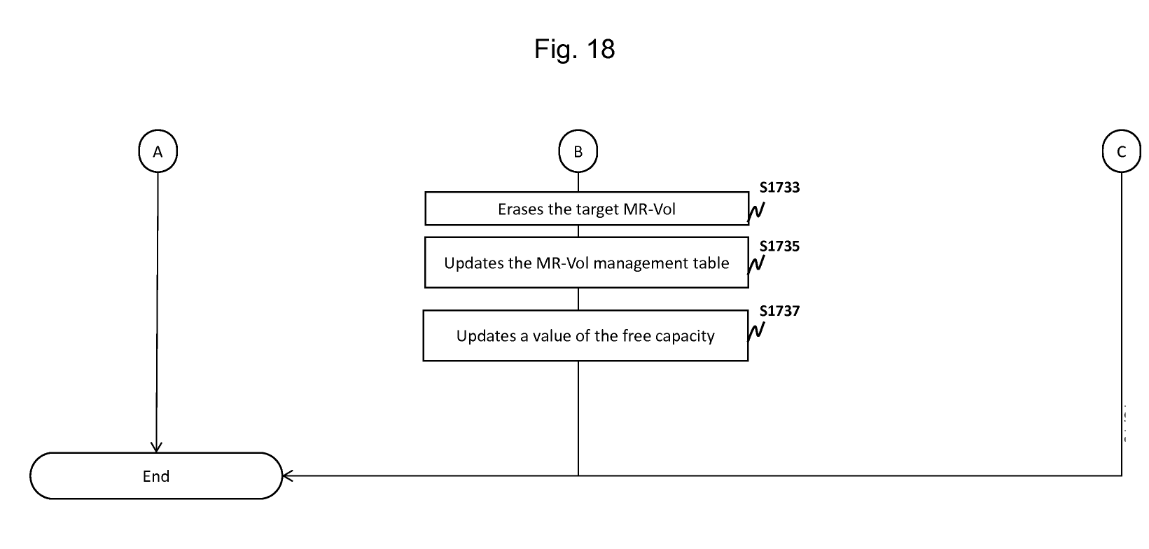

FIG. 17 is a view showing a first-half part of a flowchart of an MR-VOL erasion processing. FIG. 18 is a view showing a second-half part of a flowchart of an MR-VOL erasion processing.

The MR-VOL erasion processing is a processing of the step S1405 of the dynamic placement processing of the MR-VOL 17. As described above, an MR-VOL that is a target of this processing is referred to as a target MR-VOL.

In the step S1701, the program 407 determines whether or not it is necessary to erase the target MR-VOL 17. In this determination, it is determined that it is necessary to erase the target MR-VOL 17 in the case in which a total value of a read access frequency to all blocks of the target MR-VOL 17 is equal to or less than a predetermined threshold value (an erasion threshold value). More specifically for instance, the program 407 refers to the MR-VOL management table 404. In the case in which a value of the read hit (summation) 507 of the target MR-VOL is then equal to or less than the erasion threshold value (S1701: Yes), the program 407 goes ahead with the processing to the step S1703. On the other hand, in the case in which a value of the read hit (summation) 507 of the target MR-VOL is larger than the erasion threshold value (S1701: No) (A in the figure), the program 407 terminates the processing.

In the step S1703, in the case in which the program 407 erases the target MR-VOL 17, the program 407 determines whether or not a read access to the target MR-VOL 17 can be directed to other MR-VOL 17. More specifically for instance, the program 407 computes a free performance value that is a value obtained by subtracting the read number 806 from the limit performance 805 of the pool management table 406 for every pool 45. Moreover, the program 407 determines whether or not a total sum of a free performance value of all pools is equal to or higher than a read access frequency of the target MR-VOL 17. For instance, the program 407 determines whether or not a total sum of a free performance value of all pools is equal to or higher than a value of the read hit (summation) 705 of the MR-VOL management table 404 of the target MR-VOL 17. In the case in which a total sum of a free performance value of all pools is equal to or higher than a value of the read hit (summation) (S1703: Yes), the program 407 goes ahead with the processing to the step S1705. On the other hand, in the case in which a total sum of a free performance value of all pools is equal to or higher than a value of the read hit (summation) (S1703: No) (C in the figure), the program 407 terminates the processing.

In the step S1705, the program 407 refers to the volume related management table 408 and configures the number of HR-VOLs that are corresponded to the target MR-VOL to a variable a.

In the step S1707, the program 407 refers to the volume related management table 408 and extracts all of the HR-VOLs 13 that are corresponded to the target MR-VOL 17. The program 407 then rearranges the extracted HR-VOLs 13 in an order from the larger value of the read miss (summation) based on the HR-VOL management table 405. At this time, for the HR-VOL management table 405, the extracted HR-VOLs 13 can be rearranged, or a list of the extracted HR-VOLs 13 can also be created.

In the step S1709, the program 407 refers to the MR-VOL management table 404 and creates a second MR-VOL list of all of the MR-VOLs 17 that are included in the storage apparatus 4 except for the target MR-VOL 17.

In the step S1711, the program 407 determines whether or not an MR-VOL 17 that belongs to the pool 45 exists in the MR-VOLs 17 of the second MR-VOL list.

In the case in which an MR-VOL 17 that belongs to the pool 45 does not exist (S1711: No), the program 407 terminates the processing. On the other hand, in the case in which an MR-VOL 17 that belongs to the pool 45 exists (S1711: Yes), the program 407 goes ahead with the processing to the step S1713.

In the step S1713, the program 407 selects an arbitrary MR-VOL that belongs to the pool 45 as a migration destination MR-VOL 17.

The program 407 identifies an HR-VOL 13 of which a value of a read miss (summation) is highest for the HR-VOLs 13 that have been extracted in the step S1707 as a target HR-VOL 13. In the step S1715, in the case in which the correlating of the target HR-VOL 13 with the target MR-VOL 17 is modified to the migration destination MR-VOL 17, the program 407 determines whether or not a read access frequency to the migration destination MR-VOL 17 is less than the duplicate threshold value. More specifically for instance, the program 407 refers to the MR-VOL management table 404, the HR-VOL management table 405, and the pool management table 406. In the case in which a total value of a value of a read hit (summation) 705 of the migration destination MR-VOL 17 and a value of a read miss (summation) 903 of the target HR-VOL 17 is less than the duplicate threshold value of the migration destination MR-VOL 17 (S1715: Yes), the program 407 goes ahead with the processing to the step S1717. In the other case (S1715: No), the program 407 goes ahead with the processing to the step S1723.

In the step S1717, the program 407 erases the migration destination MR-VOL 17 from the second MR-VOL list.

In the step S1719, the program 407 determines whether or not an MR-VOL exists in the second MR-VOL list. In the case in which the MR-VOL 17 exists in the second MR-VOL list (S1719: Yes), the program 407 selects newly an arbitrary MR-VOL as the migration destination MR-VOL, and returns the processing to the step S1719. On the other hand, in the case in which all MR-VOLs have been erased from the first MR-VOL list (S1719: No) (C in the figure), the program 407 terminates the processing.

In the step S1723, the program 407 subtracts 1 from a value of a variable a. In the step S1725, the program 407 updates a value of a read hit (summation) of the migration destination MR-VOL 17. For instance, the program 407 configures a value obtained by adding a value of a read miss (summation) of the target HR-VOL 17 to a value of a read hit (summation) of the migration destination MR-VOL 17 as a value of a read hit (summation) of the target MR-VOL 17. The program 407 then updates the MR-VOL management table 404 by this value.

In the step S1727, the program 407 updates a value of the read number 806 of a pool (a target pool) to which the target MR-VOL 17 belongs for the pool management table 406 to be a value obtained by subtracting a value of a read miss (summation) of the target HR-VOL 17 from the value.

In the step S1729, the program 407 updates a value of the read number 806 of a pool (a migration destination pool) to which the migration destination MR-VOL 17 belongs for the pool management table 406 to be a value obtained by adding a value of a read miss (summation) of the target HR-VOL 17 to the value.

In the step S1731, the program 407 updates the volume related management table 408. For instance, the program 407 updates the MR-VOL that is corresponded to the target HR-VOL from the target MR-VOL to the migration destination MR-VOL.

In the step S1721, the program 407 determines whether or not the variable a is “0”. In the case in which the variable a is “0”. (S1721: Yes) (C in the figure), the program 407 terminates the processing. On the other hand, in the case in which the variable a is not “0”. (S1721: Yes) (B in the figure), the program 407 goes ahead with the processing to the step S1733.

The FIG. 18 will be described in the following. In the step S1733, the program 407 erases the target MR-VOL 17. In the step S1735, the program 407 erases an entry of the target MR-VOL of the MR-VOL management table 404. In the step S1737, the program 407 updates a value of the free capacity 807 of the pool management table 406. More specifically for instance, the program 407 makes a value of the free capacity 807 of a pool to which the target MR-VOL belongs be a value obtained by subtracting a value of a capacity of the target HR-VOL from the value, and updates a value of the free capacity 807 of a pool to which the migration destination VOL belongs to be a value obtained by adding a value of a capacity of the target HR-VOL to the value.

In the above processing, the MR-VOL (the target MR-VOL) 17 in which a read access frequency is less than a predetermined threshold value (an erasion threshold value) can be erased, and the HR-VOL 13 that has been correlated with the target MR-VOL 17 can be correlated with other MR-VOL. By erasing the target MR-VOL 17 in which a read access frequency is less, the capacity efficiency of a storage area of the storage apparatus 4 can be improved.

In the above processing moreover, a migration destination MR-VOL 17 that is a new correlated destination of an HR-VOL 13 that has been correlated with an MR-VOL 17 that is an erased target is decided based on a free performance and a free capacity of a pool to which the MR-VOL 17 belongs. By this configuration, the efficiency of a performance and a capacity of each pool can be promoted. Moreover in the above processing, a modification of the correlating of the HR-VOL 13 with the migration destination MR-VOL 17 is executed in an order from an HR-VOL 13 in which a read access frequency (a value of a read miss) is higher. By executing the correlating in an order from an MR-VOL that belongs to a pool of which a free performance is higher, a modification of the correlating can be efficiently executed.

In the present embodiment, the same data is stored in the same location (a block ID) of a block that is included in the P-VOL 15, the HR-VOL 13, and the MR-VOL 17 that are corresponded to the V-VOL 10. However the present invention is not restricted to the configuration. As long as an area of each volume in which common data is stored is corresponded to each volume, any configuration can be adopted.

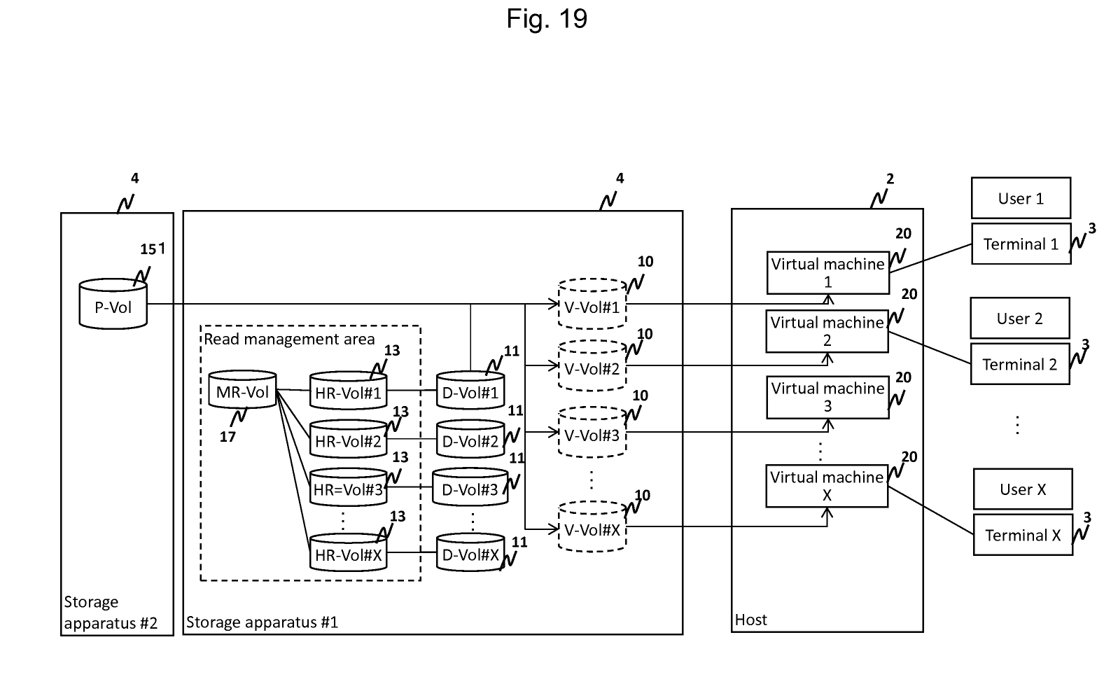

Although a computer system that is provided with one storage apparatus 4 was described above, the present invention is not restricted to the configuration. A computer system can also be provided with another storage apparatus as an external storage apparatus of one storage apparatus 4. FIG. 19 shows the configuration in which a storage apparatus #2 that is coupled to a storage apparatus #1 works as an external storage apparatus of the storage apparatus #1. As described above, the storage apparatus #2 can be provided with a volume that is associated with a V-VOL (a volume of any one of P-VOL 15, D-VOL 11, HR-VOL 13, and MR-VOL 17) as substitute for the storage apparatus #1. In the shown example, the storage apparatus #2 is provided with a P-VOL 151. In the above configuration, a processing and an effect of a computer system in accordance with this modified example are similar to those of a computer system that has been described with reference to FIG. 1. However, in the case of this computer system, a copy of the target data from the PVOL 15 to the HR-VOL 13 (FIG. 12: S1213) and a copy of the target data from the PVOL 15 to the MR-VOL 17 (FIG. 13: S1313) in the data migration processing are a remote copy from the storage apparatus #2 to the storage apparatus #1.

While an embodiment in accordance with the present invention has been described above, the present invention is not restricted to the above embodiment, and it is obvious that various changes and modifications can be thus made without departing from the scope of the present invention. In the descriptions of the above embodiment, the HR-VOL 13 and the MR-VOL 17 in addition to the P-VOL 15 and the D-VOL 11 are associated with the V-VOL 10. However, the present invention is not restricted to the above configuration. All necessary is that one volume of the HR-VOL 13 and the MR-VOL 17 is associated with the V-VOL 10.

The virtual volume is corresponded to the V-VOL 10, the basic volume is corresponded to the P-VOL 15, the auxiliary volume is corresponded to the MR-VOL 17, and the alternative volume is corresponded to the HR-VOL 13 or the like. Moreover, the area information is corresponded to the volume related management table 408 and the data reference destination management table 409 or the like. The information of an allowance of a performance is corresponded to a free performance, and the information of an allowance of a capacity is corresponded to a free capacity or the like. The virtual storage area is corresponded to a block in the V-VOL or the like. The basic storage area is corresponded to a block in the P-VOL or the like. The auxiliary storage area is corresponded to a block in the MR-VOL or the like. The alternative storage area is corresponded to a block in the HR-VOL or the like. The first copy threshold value is corresponded to the MR read miss threshold value and the HR read miss threshold value, and the second copy threshold value is corresponded to the MR read hit threshold value and the HR read hit threshold value or the like. The third copy threshold value is corresponded to the HR read miss threshold value, and the fourth copy threshold value is corresponded to the HR read hit threshold value or the like. Moreover, the step for selecting a pool in which the information indicating an allowance satisfies the predetermined condition from a plurality of pools is corresponded to the step of S1503 of FIG. 15 or the like.

1. A storage apparatus comprising:
a controller coupled to a host computer; and
a plurality of physical storage devices coupled to the controller,
the controller being configured to:
create a basic volume based on the plurality of physical storage devices;
create a first virtual volume based on the basic volume;
create a first auxiliary volume based on the plurality of physical storage devices;
store area information indicating that a basic storage area in the basic volume is associated with a first virtual storage area in a first virtual volume;
in the case in which a read request to the first virtual storage area is issued from the host computer, determine whether or not a first auxiliary storage area in the first auxiliary volume is associated with the first virtual storage area based on the area information;
in the case in which the first auxiliary storage area is not associated with the first virtual storage area, execute a read access to the basic storage area;
measure a read access frequency to the basic storage area;
in the case in which a read access frequency to the basic storage area is a value equal to or larger than a predetermined first copy threshold value, copy data of the basic storage area to the first auxiliary storage area; and
store that the first auxiliary storage area as substitute for the basic storage area is associated with the first virtual storage area into the area information, wherein the controller is configured to:
in the case in which the read access frequency to the basic storage area is a value less than a predetermined second copy threshold value, store that the basic storage area as substitute for the first auxiliary storage area is associated with the first virtual storage area into the area information;
create a first pool based on the plurality of physical storage devices; and
allocate a physical storage area in the first pool to the first auxiliary volume;
create a plurality of pools including the first pool based on the plurality of physical storage devices; and
create a second virtual volume based on the basic volume,
wherein the area information indicates that the first auxiliary storage area is associated with a second virtual storage area in the second virtual volume and the first auxiliary storage area is associated with the first virtual storage area, and wherein the controller is configured to:
in the case in which a read request to the first virtual storage area is issued from the host computer, determine whether or not the first auxiliary storage area is associated with the first virtual storage area based on the area information;
in the case in which the first auxiliary storage area is associated with the first virtual storage area, execute a read access to the first auxiliary storage area;
in the case in which a read request to the second virtual storage area is issued from the host computer, determine whether or not the first auxiliary storage area is associated with the second virtual storage area based on the area information;
in the case in which the first auxiliary storage area is associated with the second virtual storage area, execute a read access to the first auxiliary storage area;
measure a read access frequency to the first auxiliary storage area;
compute a read access frequency to the first auxiliary volume based on a read access frequency to the first auxiliary storage area;
determine whether or not a read access frequency to the first auxiliary volume is equal to or larger than a predetermined duplicate threshold value;
in the case in which a read access frequency to the first auxiliary volume is equal to or larger than the duplicate threshold value, allocate a physical storage area in the plurality of pools to a second auxiliary storage area in the second auxiliary volume;
copy data in the first auxiliary storage area to the second auxiliary storage area; and
store that the second auxiliary storage area as substitute for the first auxiliary storage area is associated with the second virtual storage area into the area information.

2-4. (canceled)

5. A storage apparatus according to claim 1,
wherein the controller is configured to:
create a first alternative volume based on the plurality of physical storage devices;
in the case in which a read request to the first virtual storage area is issued from the host computer, determine whether or not a first alternative storage area in the first alternative volume is associated with the first virtual storage area based on the area information;
in the case in which the first alternative storage area is not associated with the first virtual storage area, determine whether or not the first auxiliary storage area is associated with the first virtual storage area based on the area information;
in the case in which the first auxiliary storage area is associated with the first virtual storage area, execute a read access to the first alternative storage area;
measure a read access frequency to the first auxiliary storage area and the basic storage area;
in the case in which a read access frequency to the first auxiliary storage area and the basic storage area is a predetermined value equal to or larger than a third copy threshold value larger than the first copy threshold value, copy data of the basic storage area to the first alternative storage area; and
store that the first alternative storage area as substitute for the basic storage area is associated with the first virtual storage area into the area information.

6. A storage apparatus according to claim 5,
wherein the controller is configured to:
measure a read access frequency to the first alternative storage area; and
in the case in which a read access frequency to the first alternative storage area is a predetermined value less than a fourth copy threshold value larger than the second copy threshold value, store that the basic storage area as substitute for the first alternative storage area is associated with the first virtual storage area into the area information.

7. A storage apparatus according to claim 6,
wherein the controller is configured to:
in the case in which a read request to the second virtual storage area is issued from the host computer, determine whether or not the second auxiliary storage area is associated with the second virtual storage area based on the area information;
in the case in which the second auxiliary storage area is associated with the second virtual storage area, execute a read access to the second auxiliary storage area;
measure a read access frequency to the second auxiliary storage area;
compute a read access frequency to the second auxiliary volume based on a read access frequency to the second auxiliary storage area;
determine whether or not a read access frequency to the second auxiliary volume is less than a predetermined erasion threshold value; and
in the case in which a read access frequency to the second auxiliary volume is less than the erasion threshold value, associate the first auxiliary storage area as substitute for the second auxiliary storage area with the second virtual storage area.

8. A storage apparatus according to claim 7,
wherein the controller is configured to:
store information indicating an allowance of a performance and a capacity for each of the plurality of pools; and
in the case in which a read access frequency to the first auxiliary volume is equal to or larger than the duplicate threshold value, select a pool in which the information indicating the allowance satisfies a prescribed condition from the plurality of pools and allocate a physical storage area in the selected pool to a second auxiliary volume.

9. A storage apparatus according to claim 8,
wherein the controller is configured to:
create a plurality of virtual volumes including the first and second virtual volumes based on the basic volume; and
create a plurality of alternative volumes including the first alternative volume based on the plurality of physical storage devices;
wherein the area information indicates that a storage area in each of the plurality of alternative volumes is associated with a storage area in the plurality of virtual volumes, and
wherein the controller is configured to:
measure a frequency of determining whether or not a storage area in the corresponded alternative volume is associated with the first virtual storage area as a determination frequency to each of the plurality of virtual volumes; and
select a virtual volume provided with the highest determination frequency among the plurality of virtual volumes as the second virtual volume.

10. A computer system comprising:
a host computer; and
a storage apparatus coupled to the host computer,
the storage apparatus comprising a controller and a plurality of physical storage devices,
the controller being configured to:
create a basic volume based on the plurality of physical storage devices;
create a first virtual volume based on the basic volume;
create a first auxiliary volume based on the plurality of physical storage devices;
store area information indicating that a basic storage area in the basic volume is associated with a first virtual storage area in a first virtual volume;
in the case in which a read request to the first virtual storage area is issued from the host computer, determine whether or not a first auxiliary storage area in the first auxiliary volume is associated with the first virtual storage area based on the area information;
in the case in which the first auxiliary storage area is not associated with the first virtual storage area, execute a read access to the basic storage area;
measure a read access frequency to the basic storage area;
in the case in which the read access frequency to the basic storage area is a value equal to or larger than a predetermined first copy threshold value, copy data of the basic storage area to the first auxiliary storage area; and
store that the first auxiliary storage area as substitute for the basic storage area is associated with the first virtual storage area into the area information, wherein the controller is configured to:
in the case in which the read access frequency to the basic storage area is a value less than a predetermined second copy threshold value, store that the basic storage area as substitute for the first auxiliary storage area is associated with the first virtual storage area into the area information;
create a first pool based on the plurality of physical storage devices;
allocate a physical storage area in the first pool to the first auxiliary volume;
create a plurality of pools including the first pool based on the plurality of physical storage devices; and
create a second virtual volume based on the basic volume,
wherein the area information indicates that the first auxiliary storage area is associated with a second virtual storage area in the second virtual volume and the first auxiliary storage area is associated with the first virtual storage area, and wherein the controller is configured to:
in the case in which a read request to the first virtual storage area is issued from the host computer, determine whether or not the first auxiliary storage area is associated with the first virtual storage area based on the area information;
in the case in which the first auxiliary storage area is associated with the first virtual storage area, execute a read access to the first auxiliary storage area;
in the case in which a read request to the second virtual storage area is issued from the host computer, determine whether or not the first auxiliary storage area is associated with the second virtual storage area based on the area information;
in the case in which the first auxiliary storage area is associated with the second virtual storage area, execute a read access to the first auxiliary storage area;
measure a read access frequency to the first auxiliary storage area;
compute a read access frequency to the first auxiliary volume based on a read access frequency to the first auxiliary storage area;
determine whether or not a read access frequency to the first auxiliary volume is equal to or larger than a predetermined duplicate threshold value;
in the case in which a read access frequency to the first auxiliary volume is equal to or larger than the duplicate threshold value, allocate a physical storage area in the plurality of pools to a second auxiliary storage area in the second auxiliary volume;
copy data in the first auxiliary storage area to the second auxiliary storage area; and
store that the second auxiliary storage area as substitute for the first auxiliary storage area is associated with the second virtual storage area into the area information.

11. A computer system comprising:
a host computer;
a first storage apparatus coupled to the host computer; and
a second storage apparatus coupled to the first storage apparatus,
the plurality of storage apparatuses comprising a controller and a plurality of physical storage devices,
the controller of the second storage apparatus being configured to:
create a first basic volume based on the plurality of physical storage devices;
the controller of the first storage apparatus being configured to:
create a first virtual volume based on the first basic volume;
create a first auxiliary volume based on the plurality of physical storage devices;
store area information indicating that a basic storage area in the first basic volume is associated with a first virtual storage area in a first virtual volume;
in the case in which a read request to the first virtual storage area is issued from the host computer, determine whether or not a first auxiliary storage area in the first auxiliary volume is associated with the first virtual storage area based on the area information;
in the case in which the first auxiliary storage area is not associated with the first virtual storage area, execute a read access to the basic storage area;
measure a read access frequency to the basic storage area;
in the case in which the read access frequency to the basic storage area is a value equal to or larger than a predetermined first copy threshold value, acquire data of the basic storage area from the first basic volume and copy the data to the first auxiliary storage area; and
store that the first auxiliary storage area as substitute for the basic storage area is associated with the first virtual storage area into the area information, wherein the controller of the second storage apparatus is configured to:
in the case in which the read access frequency to the basic storage area is a value less than a predetermined second copy threshold value, store that the basic storage area as substitute for the first auxiliary storage area is associated with the first virtual storage area into the area information;
create a first pool based on the plurality of physical storage devices; and
allocate a physical storage area in the first pool to the first auxiliary volume;
create a plurality of pools including the first pool based on the plurality of physical storage devices; and
create a second virtual volume based on the basic volume,
wherein the area information indicates that the first auxiliary storage area is associated with a second virtual storage area in the second virtual volume and the first auxiliary storage area is associated with the first virtual storage area, and wherein the controller of the first storage area is configured to:
in the case in which a read request to the first virtual storage area is issued from the host computer, determine whether or not the first auxiliary storage area is associated with the first virtual storage area based on the area information;
in the case in which the first auxiliary storage area is associated with the first virtual storage area, execute a read access to the first auxiliary storage area;
in the case in which a read request to the second virtual storage area is issued from the host computer, determine whether or not the first auxiliary storage area is associated with the second virtual storage area based on the area information;
in the case in which the first auxiliary storage area is associated with the second virtual storage area, execute a read access to the first auxiliary storage area;
measure a read access frequency to the first auxiliary storage area;
compute a read access frequency to the first auxiliary volume based on a read access frequency to the first auxiliary storage area;
determine whether or not a read access frequency to the first auxiliary volume is equal to or larger than a predetermined duplicate threshold value;
in the case in which a read access frequency to the first auxiliary volume is equal to or larger than the duplicate threshold value, allocate a physical storage area in the plurality of pools to a second auxiliary storage area in the second auxiliary volume;
copy data in the first auxiliary storage area to the second auxiliary storage area; and
store that the second auxiliary storage area as substitute for the first auxiliary storage area is associated with the second virtual storage area into the area information.

12. A method executed by a storage apparatus comprising a controller coupled to a host computer and a plurality of physical storage devices coupled to the controller, comprising
creating a basic volume based on the plurality of physical storage devices;
creating a first virtual volume based on the basic volume;
creating a first auxiliary volume based on the plurality of physical storage devices;
storing area information indicating that a basic storage area in the basic volume is associated with a first virtual storage area in a first virtual volume;
in the case in which a read request to the first virtual storage area is issued from the host computer, determining whether or not a first auxiliary storage area in the first auxiliary volume is associated with the first virtual storage area based on the area information;
in the case in which the first auxiliary storage area is not associated with the first virtual storage area, executing a read access to the basic storage area;
measuring a read access frequency to the basic storage area;
in the case in which the read access frequency to the basic storage area is a value equal to or larger than a predetermined first copy threshold value, copying data of the basic storage area to the first auxiliary storage area; and
storing that the first auxiliary storage area as substitute for the basic storage area is associated with the first virtual storage area into the area information, wherein
in the case in which the read access frequency to the basic storage area is a value less than a predetermined second copy threshold value, storing that the basic storage area as substitute for the first auxiliary storage area is associated with the first virtual storage area into the area information;
creating a first pool based on the plurality of physical storage devices;
allocating a physical storage area in the first pool to the first auxiliary volume;
creating a plurality of pools including the first pool based on the plurality of physical storage devices; and
creating a second virtual volume based on the basic volume,
wherein the area information indicates that the first auxiliary storage area is associated with a second virtual storage area in the second virtual volume and the first auxiliary storage area is associated with the first virtual storage area, and
in the case in which a read request to the first virtual storage area is issued from the host computer, determining whether or not the first auxiliary storage area is associated with the first virtual storage area based on the area information;
in the case in which the first auxiliary storage area is associated with the first virtual storage area, executing a read access to the first auxiliary storage area;
in the case in which a read request to the second virtual storage area is issued from the host computer, determining whether or not the first auxiliary storage area is associated with the second virtual storage area based on the area information;
in the case in which the first auxiliary storage area is associated with the second virtual storage area, executing a read access to the first auxiliary storage area;
measure a read access frequency to the first auxiliary storage area;
computing a read access frequency to the first auxiliary volume based on a read access frequency to the first auxiliary storage area;
determining whether or not a read access frequency to the first auxiliary volume is equal to or larger than a predetermined duplicate threshold value;
in the case in which a read access frequency to the first auxiliary volume is equal to or larger than the duplicate threshold value, allocating a physical storage area in the plurality of pools to a second auxiliary storage area in the second auxiliary volume;
coping data in the first auxiliary storage area to the second auxiliary storage area; and
storing that the second auxiliary storage area as substitute for the first auxiliary storage area is associated with the second virtual storage area into the area information.
